(19) United States
(12) Patent Application Publication
(10) Pub. No.: US 2026/0269965 A1
(43) Pub. Date: Sep. 10, 2026

(54) USER EQUIPMENT RECOMMENDATION OF CHANNEL MEASUREMENT RESOURCES IN USER EQUIPMENT BASED BEAM PREDICTION

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Hamed PEZESHKI, San Diego, CA (US)

(21) Appl. No.: 19/473,291

(22) PCT Filed: Jun. 9, 2023
(86) PCT No.: PCT/CN2023/099277

§ 371 Date: Oct. 7, 2025

(51) Int. Cl. H04B 17/373; H04B 7/06; H04B 17/391

(52) U.S. Cl. CPC H04B 17/373; H04B 7/0626; H04B 17/3913

(57) ABSTRACT

Various aspects of the present disclosure generally relate to wireless communication. In some aspects, a user equipment (UE) may receive configuration information indicating one or more channel prediction resources (CPRs) associated with a channel state information (CSI) report and one or more first channel measurement resources (CMRs) to be used for predicting measurements for the one or more CPRs. The UE may perform measurements of the one or more first CMRs. The UE may transmit a first CSI report including first predicted measurement values associated with the one or more CPRs, the first predicted measurement values in accordance with the measurements of the one or more first CMRs. The UE may transmit an indication of one or more second CMRs to be used for predicting measurements for the one or more CPRs. Numerous other aspects are described.

### FIELD OF THE DISCLOSURE

Aspects of the present disclosure generally relate to wireless communication and specifically, to techniques and apparatuses for user equipment (UE) recommendation of channel measurement resources in UE-based beam prediction.

### BACKGROUND

Wireless communication systems are widely deployed to provide various telecommunication services such as telephony, video, data, messaging, and broadcasts.

Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE).

LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different user equipments (UEs) to communicate on a municipal, national, regional, or global level.

New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

Wireless networks may operate at higher frequency bands, such as within millimeter wave bands, to offer high data rates. In some examples, wireless devices, such as a network node and a UE, may communicate with each other through beamforming techniques to increase communication speed and reliability. The beamforming techniques may enable a wireless device to transmit a signal in a particular direction instead of transmitting an omnidirectional signal in all directions. In some examples, the wireless device may transmit a signal from multiple antenna elements using a common wavelength and phase for the transmission from the multiple antenna elements, and the signal from the multiple antenna elements may be combined to create a combined signal with a longer range and a more directed beam. The beamwidth of the signal may vary based on the transmitting frequency. For example, higher frequency bands may enable wireless devices to form much narrower beam structures, as compared to the beam structures formed using lower frequency bands. In addition, the higher frequency bands may provide a large available bandwidth. The transmission path of a narrower beam may be more likely to be tailored to a receiver, such that the transmission may be more likely to meet a line-of-sight (LOS) condition as the narrower beam may be more likely to reach the receiver without being obstructed by obstacle(s). Also, as the transmission path may be narrow, reflection and/or refraction may be less likely to occur for the narrower beam.

While higher frequency bands may provide narrower beam structures and higher transmission rates, higher frequency bands may also encounter higher attenuation and diffraction losses, where a blockage of an LOS path may degrade a wireless link quality. As a result, wireless communications using higher frequency bands may be more susceptible to environmental changes, as compared to wireless communications using lower frequency bands. Beam management procedures may be performed by a UE and/or a network node to select a best beam or beam pair for communications between the UE and the network node. However, because higher frequency bands may be more susceptible to environmental changes than lower frequency bands, the beam management procedures may need to be performed more frequently and/or using additional beams.

This may introduce significant overhead and consume network resources, processing resources, and/or power resources of a UE (and/or a network node) associated with performing the beam management procedures.

### SUMMARY

Some aspects described herein relate to an apparatus for wireless communication at a user equipment (UE). The apparatus may include one or more memories storing processor-readable code and one or more processors coupled with the one or more memories. At least one processor of the one or more processors may be configured to cause the UE to receive, from a network node, configuration information indicating one or more channel prediction resources (CPRs) associated with a channel state information (CSI) report and one or more first channel measurement resources (CMRs) to be used for predicting measurements for the one or more CPRs. At least one processor of the one or more processors may be configured to cause the UE to perform measurements of the one or more first CMRs. At least one processor of the one or more processors may be configured to cause the UE to transmit, to the network node, a first CSI report including first predicted measurement values associated with the one or more CPRs, the first predicted measurement values in accordance with the measurements of the one or more first CMRs. At least one processor of the one or more processors may be configured to cause the UE to transmit, to the network node, an indication of one or more second CMRs to be used for predicting measurements for the one or more CPRs.

Some aspects described herein relate to an apparatus for wireless communication at a network node. The apparatus may include one or more memories storing processor-executable code and one or more processors coupled with the one or more memories. At least one processor of the one or more processors may be configured to cause the network node to transmit, to a UE, configuration information indicating one or more CPRs associated with a CSI report and one or more first CMRs to be used for predicting measurements for the one or more CPRs. At least one processor of the one or more processors may be configured to cause the network node to receive, from the UE, a first CSI report including first predicted measurement values associated with the one or more CPRs, the first predicted measurement values in accordance with measurements of the one or more first CMRs. At least one processor of the one or more processors may be configured to cause the network node to receive, from the UE, an indication of one or more second CMRs to be used for predicting measurements for the one or more CPRs.

Some aspects described herein relate to a method of wireless communication performed at a UE. The method may include receiving, from a network node, configuration information indicating one or more CPRs associated with a CSI report and one or more first CMRs to be used for predicting measurements for the one or more CPRs. The method may include performing measurements of the one or more first CMRs. The method may include transmitting, to the network node, a first CSI report including first predicted measurement values associated with the one or more CPRs, the first predicted measurement values in accordance with the measurements of the one or more first CMRs. The method may include transmitting, to the network node, an indication of one or more second CMRs to be used for predicting measurements for the one or more CPRs.

Some aspects described herein relate to a method of wireless communication performed at a network node. The method may include transmitting, to a UE, configuration information indicating one or more CPRs associated with a CSI report and one or more first CMRs to be used for predicting measurements for the one or more CPRs. The method may include receiving, from the UE, a first CSI report including first predicted measurement values associated with the one or more CPRs, the first predicted measurement values in accordance with measurements of the one or more first CMRs. The method may include receiving, from the UE, an indication of one or more second CMRs to be used for predicting measurements for the one or more CPRs.

Some aspects described herein relate to a non-transitory computer-readable medium that stores a set of instructions for wireless communication by a UE. The set of instructions, when executed by one or more processors of the UE, may cause the UE to receive, from a network node, configuration information indicating one or more CPRs associated with a CSI report and one or more first CMRs to be used for predicting measurements for the one or more CPRs. The set of instructions, when executed by one or more processors of the UE, may cause the UE to perform measurements of the one or more first CMRs. The set of instructions, when executed by one or more processors of the UE, may cause the UE to transmit, to the network node, a first CSI report including first predicted measurement values associated with the one or more CPRs, the first predicted measurement values in accordance with the measurements of the one or more first CMRs. The set of instructions, when executed by one or more processors of the UE, may cause the UE to transmit, to the network node, an indication of one or more second CMRs to be used for predicting measurements for the one or more CPRs.

Some aspects described herein relate to a non-transitory computer-readable medium that stores a set of instructions for wireless communication by a network node.

The set of instructions, when executed by one or more processors of the network node, may cause the network node to transmit, to a UE, configuration information indicating one or more CPRs associated with a CSI report and one or more first CMRs to be used for predicting measurements for the one or more CPRs. The set of instructions, when executed by one or more processors of the network node, may cause the network node to receive, from the UE, a first CSI report including first predicted measurement values associated with the one or more CPRs, the first predicted measurement values in accordance with measurements of the one or more first CMRs. The set of instructions, when executed by one or more processors of the network node, may cause the network node to receive, from the UE, an indication of one or more second CMRs to be used for predicting measurements for the one or more CPRs.

Some aspects described herein relate to an apparatus for wireless communication. The apparatus may include means for receiving, from a network node, configuration information indicating one or more CPRs associated with a CSI report and one or more first CMRs to be used for predicting measurements for the one or more CPRs. The apparatus may include means for performing measurements of the one or more first CMRs. The apparatus may include means for transmitting, to the network node, a first CSI report including first predicted measurement values associated with the one or more CPRs, the first predicted measurement values in accordance with the measurements of the one or more first CMRs. The apparatus may include means for transmitting, to the network node, an indication of one or more second CMRs to be used for predicting measurements for the one or more CPRs.

Some aspects described herein relate to an apparatus for wireless communication. The apparatus may include means for transmitting, to a UE, configuration information indicating one or more CPRs associated with a CSI report and one or more first CMRs to be used for predicting measurements for the one or more CPRs. The apparatus may include means for receiving, from the UE, a first CSI report including first predicted measurement values associated with the one or more CPRs, the first predicted measurement values in accordance with measurements of the one or more first CMRs. The apparatus may include means for receiving, from the UE, an indication of one or more second CMRs to be used for predicting measurements for the one or more CPRs.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating examples of beam management procedures, in accordance with the present disclosure.

FIG. 4 is a diagram illustrating an example architecture of a functional framework for radio access network intelligence enabled by data collection, in accordance with the present disclosure.

FIG. 5 is a diagram illustrating an example of an artificial intelligence/machine learning based beam management, in accordance with the present disclosure.

FIGS. 6A-6D are diagrams illustrating an example associated with UE recommendation of channel measurement resources (CMRs) in UE-based beam prediction, in accordance with the present disclosure.

FIG. 7 is a flowchart illustrating an example process performed, for example, by a UE that supports UE recommendation of CMRs in UE-based beam prediction in accordance with the present disclosure.

FIG. 8 is a flowchart illustrating an example process performed, for example, by a network node that supports UE recommendation of CMRs in UE-based beam prediction in accordance with the present disclosure.

FIGS. 9-10 are diagrams of example apparatuses for wireless communication that support UE recommendation of CMRs in UE-based beam prediction in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples, artificial intelligence (AI) and/or machine learning (ML) (AI/ML) may be used by a user equipment (UE) and/or a network node for beam management. For example, an AI/ML model may be deployed at or on a UE and/or at or on a network node, and the AI/ML model may enable the UE and/or the network node to determine one or more inferences or predictions based on data input to the AI/ML model. In some examples, an input to the AI/ML model may include measurements (e.g., layer 1 (L1) reference signal received power (RSRP) measurements) associated with a first set of beams. For example, the UE may perform the measurements associated with the first set of beams, and the UE may input the measurements into the AI/ML model. The AI/ML model may output one or more predictions. The one or more predictions may include predicted measurement values (e.g., predicted L1 RSRP measurement values) associated with a second set of beams. This may reduce a quantity of beam measurements that are performed by the UE, thereby conserving power of the UE and/or network resources that would have otherwise been used to measure all beams included in the first set of beams and the second set of beams.

In some examples, the first set of beams (e.g., that are measured) may be referred to as Set B beams, and the second set of beams (e.g., that are associated with predicted measurements) may be referred to as Set A beams. In some examples, the Set B beams may be a subset of the Set A beams. For example, the Set B beams may be spatially down-sampled beams of the Set A beams. In some other examples, the Set B beams and the Set A beams may be different beams and/or may be mutually exclusive sets. In some examples, the Set B beams may be fixed over time and/or may follow a set or predictable pattern. For example, at various time domain measurement occasions, the Set B beams, to be measured by the UE to facilitate a prediction of measurements of the Set A beams, may be fixed or may follow a set pattern.

In examples in which a UE performs beam measurement predictions (e.g., using an AI/ML model deployed at the UE), a network node may determine the selection of Set B beams to be measured by the UE 120. In some examples, using a fixed set of Set B beams over time may degrade a performance of predictions made by the AI/ML model (e.g., that is deployed at the UE). For example, one or more beams included in the Set B beams may be associated with a beam blockage, interference, or another intervening factor that degrades performances of signals communicated via the one or more beams.

For example, higher frequency bands may encounter higher attenuation and diffraction losses, where a blockage of a line-of-sight (LOS) path may degrade a wireless link quality. Therefore, using a fixed set of Set B beams over time may result in inaccurate or degraded performance of predicting measurements for beams included in the Set A. In some examples, the network node may determine a pattern for varying the Set B beams over different time domain measurement occasions. For example, the network node may indicate, to the UE, a semi-random pattern for selecting the Set B beams over different time domain measurement occasions or different channel measurement resource (CMR) sets associated with different time domain measurement occasions. In some examples, information may be available at the UE (such as information relating to a UE mobility, orientation, a position, and/or a capability, among other examples) that could improve the selection of the Set B beams and result in increased accuracy of the predicted measurements of the Set A beams. However, such information may not be available at the network node, and thus not used by the network node to determine the selection of the Set B beams.

Various aspects relate generally to UE-based beam prediction. Some aspects more specifically relate to UE recommendation of CMRs to be measured for UE-based prediction of beam measurements. In some aspects, a UE may receive, from a network node, configuration information indicating one or more channel prediction resources (CPRs) associated with a channel state information (CSI) report. The CPRs may be resources corresponding to beams (e.g., Set A beams) for which predicted measurement values are to be reported in the CSI report. The configuration may also indicate first CMRs to be used for predicting the measurement values for the CPRs. For example, the first CMRs may correspond to a first set of Set B beams. The UE may perform measurements of the first CMRs, and the UE may predict measurement values for the CPRs (e.g., using an AI/ML model deployed at the UE) based on or otherwise associated with the measurements of the first CMRs. The UE may transmit, to the network node, a first CSI report including the predicted measurement values for the CPRs, and the UE may transmit, to the network node, an indication of one or more second CMRs to be used for predicting measurements for the CPRs. For example, the second CMRs may be CMRs recommended by the UE (e.g., CMRs corresponding to recommended Set B beams) to be used by the UE for predicting the measurements for the CPRs in one or more subsequent time domain measurement occasions. In some examples, the indication of the second CMRs may be included in a medium access control (MAC) control element (MAC-CE) transmitted from the UE to the network node. In some examples, the indication of the second CMRs may be included in the first CIS report that indicates the predicted measurement values for the CPRs determined using the measurements of the first CMRs. In some examples, the UE may perform measurements of the second CMRs in connection with transmitting the indication of the second CMRs, and the UE may transmit, to the network node a second CSI report indicating predicted measurement values for the CPRs determined (e.g., using the AI/ML model deployed at the UE) based on or otherwise associated with the measurements of the second CMRs.

Particular aspects of the subject matter described in this disclosure can be implemented to realize one or more of the following potential advantages. In some examples, the described techniques can be used to enable UE recommendation of CMRs (e.g., corresponding to Set B beams) to be used for UE-based prediction of measurements for CPRs (e.g., corresponding to Set A beams). In some examples, information that can improve the selection of the CMRs to be used for beam measurement prediction (e.g., information relating to UE mobility, orientation, position, and/or capability, among other examples) may be available to the UE, but not available to the network node. Accordingly, by enabling the UE to recommend CMRs (e.g., corresponding to Set B beams) to be used for beam measurement prediction, the described techniques can be used to improve the selection of the CMRs, resulting in increased accuracy of predicted measurement values for the CPRs (e.g., predicted measurement values associated with the Set A beams).

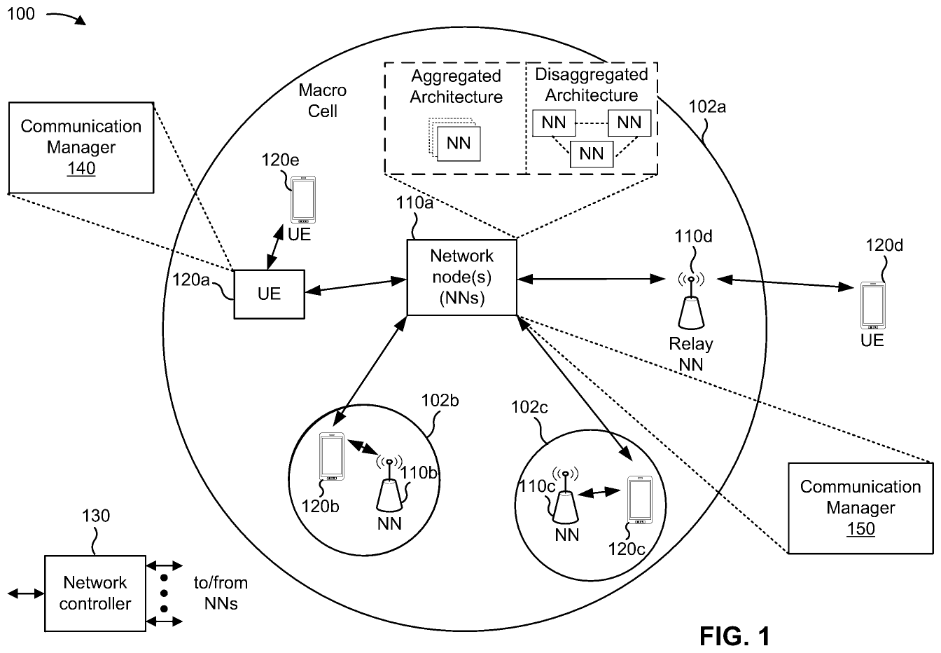

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a UE 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, and/or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c.

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), and/or a Non-Real Time (Non-RT) RIC. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive, from a network node, configuration information indicating one or more CPRs associated with a CSI report and one or more first CMRs to be used for predicting measurements for the one or more CPRs; perform measurements of the one or more first CMRs; transmit, to the network node, a first CSI report including first predicted measurement values associated with the one or more CPRs, the first predicted measurement values in accordance with the measurements of the one or more first CMRs; and transmit, to the network node, an indication of one or more second CMRs to be used for predicting measurements for the one or more CPRs. Additionally, or alternatively, the communication manager 140 may perform one or more other operations described herein.

In some aspects, the network node 110 may include a communication manager 150. As described in more detail elsewhere herein, the communication manager 150 may transmit, to a UE, configuration information indicating one or more CPRs associated with a CSI report and one or more first CMRs to be used for predicting measurements for the one or more CPRs; receive, from the UE, a first CSI report including first predicted measurement values associated with the one or more CPRs, the first predicted measurement values in accordance with measurements of the one or more first CMRs; and receive, from the UE, an indication of one or more second CMRs to be used for predicting measurements for the one or more CPRs. Additionally, or alternatively, the communication manager 150 may perform one or more other operations described herein.

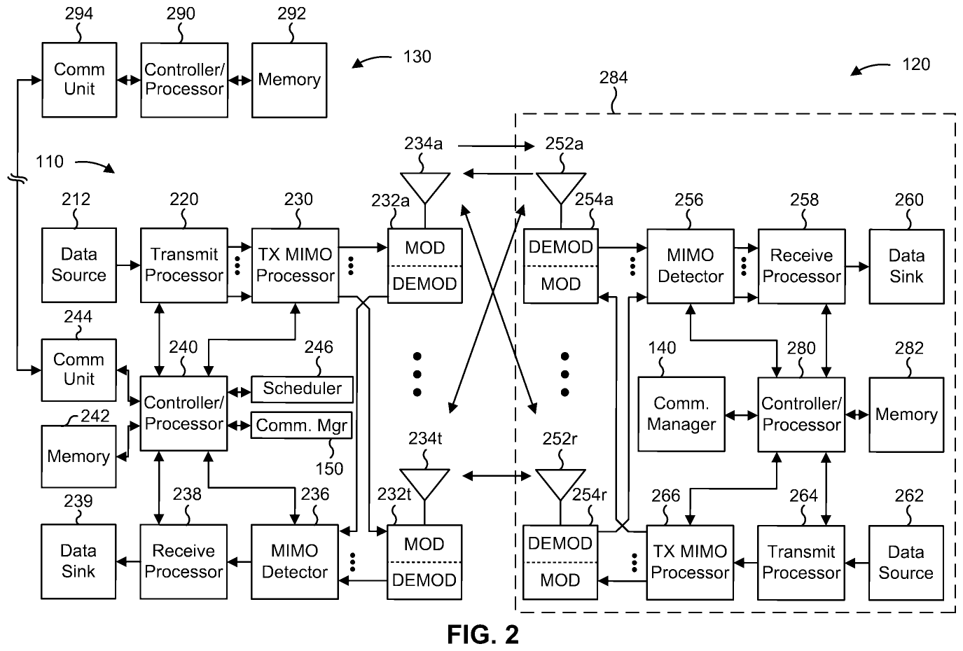

FIG. 2 is a diagram illustrating an example network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, Toutput symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers and/or one or more processors. A channel processor may determine an RSRP parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

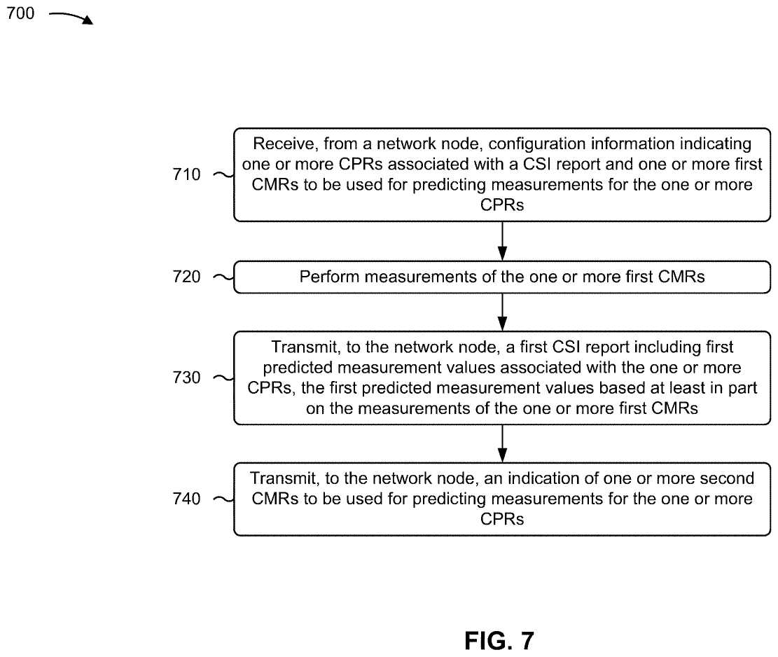

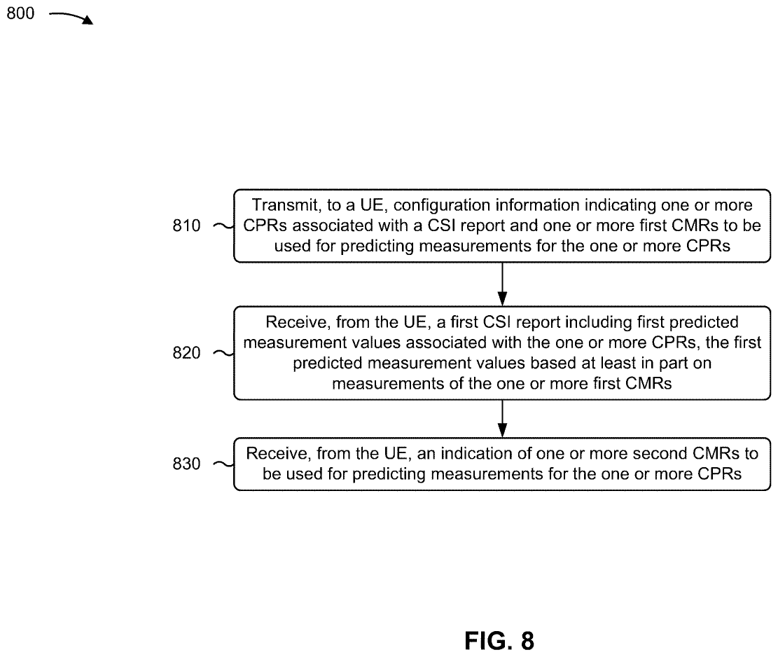

The controller/processor 240 of the network node 110, the controller/processor 280 of the UE 120, or any other component(s) of FIG. 2 may perform one or more techniques associated with UE recommendation of CMRs in UE-based beam prediction, as described in more detail elsewhere herein. For example, the controller/processor 240 of the network node 110, the controller/processor 280 of the UE 120, or any other component(s) of FIG. 2 may perform or direct operations of, for example, process 700 of FIG. 7, process 800 of FIG. 8, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 700 of FIG. 7, process 800 of FIG. 8, or other processes as described herein. In some examples, executing instructions may include running the instructions, converting the instructions, compiling the instructions, or interpreting the instructions, among other examples. In some implementations, one or more of the multiple memories may be configured to store processor-executable code that, when executed, may configure the one or more processors to perform various functions described herein (as part of a processing system). In some other implementations, the processing system may be pre-configured to perform various functions described herein.

In some aspects, a UE (e.g., the UE 120) includes means for receiving, from a network node, configuration information indicating one or more CPRs associated with a CSI report and one or more CMRs to be used for predicting measurements for the one or more CPRs; means for performing measurements of the one or more first CMRs; means for transmitting, to the network node, a first CSI report including first predicted measurement values associated with the one or more CPRs, the first predicted measurement values in accordance with the measurements of the one or more first CMRs; and/or means for transmitting, to the network node, an indication of one or more second CMRs to be used for predicting measurements for the one or more CPRs. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting, to a UE, configuration information indicating one or more CPRs associated with a CSI report and one or more first CMRs to be used for predicting measurements for the one or more CPRs; means for receiving, from the UE, a first CSI report including first predicted measurement values associated with the one or more CPRs, the first predicted measurement values in accordance with measurements of the one or more first CMRs; and/or means for receiving, from the UE, an indication of one or more second CMRs to be used for predicting measurements for the one or more CPRs. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, and/or one or more RUs).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

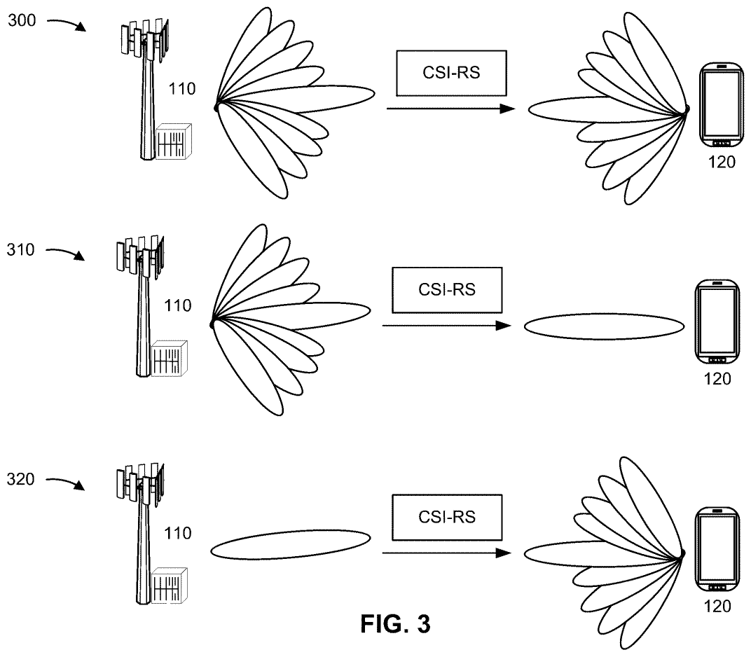

FIG. 3 is a diagram illustrating examples 300, 310, and 320 of beam management procedures, in accordance with the present disclosure. As shown in FIG. 3, examples 300, 310, and 320 include a UE 120 in communication with a network node 110 in a wireless network (e.g., wireless network 100). However, the devices shown in FIG. 3 are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., a radio resource control (RRC) connected state).

As shown in FIG. 3, example 300 may include a network node 110 (e.g., one or more network node devices such as an RU, a DU, and/or a CU, among other examples) and a UE 120 communicating to perform beam management using CSI reference signals (CSI-RSs). Example 300 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 3 and example 300, CSI-RSs may be configured to be transmitted from the network node 110 to the UE 120. The CSI-RSs may be configured to be periodic (e.g., using RRC signaling), semi-persistent (e.g., using MAC-CE signaling), and/or aperiodic (e.g., using downlink control information (DCI)).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 300 has been described in connection with CSI-RSs, the first beam management process may also use synchronization signal blocks (SSBs) for beam management in a similar manner as described above.

As shown in FIG. 3, example 310 may include a network node 110 and a UE 120 communicating to perform beam management using CSI-RSs. Example 310 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 3 and example 310, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based on or otherwise in accordance with measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based on or otherwise in accordance with measurements performed in connection with the first beam management procedure). The second beam management procedure may enable the network node 110 to select a best transmit beam based on or otherwise in accordance with measurements of the CSI-RSs (e.g., measured by the UE 120 using the single receive beam) reported by the UE 120.

As shown in FIG. 3, example 320 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 3 and example 320, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based on or otherwise in accordance with measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based on or otherwise in accordance with measurements performed in connection with the first beam management procedure and/or the second beam management procedure). The third beam management procedure may enable the network node 110 and/or the UE 120 to select a best receive beam based on or otherwise in accordance with reported measurements received from the UE 120 (e.g., of the CSI-RS of the transmit beam using the one or more receive beams).

Wireless networks may operate at higher frequency bands, such as within millimeter wave (mmW) bands (e.g., FR2 above 28 GHz, FR4 above 60 GHz, or THz band above 100 GHz, among other examples), to offer high data rates. For example, wireless devices, such as a network node and a UE, may communicate with each other through beamforming techniques to increase communication speed and reliability. The beamforming techniques may enable a wireless device to transmit a signal toward a particular direction instead of transmitting an omnidirectional signal in all directions. In some examples, the wireless device may transmit a signal from multiple antenna elements using a common wavelength and phase for the transmission from the multiple antenna elements, and the signal from the multiple antenna elements may be combined to create a combined signal with a longer range and a more directed beam. The beamwidth of the signal may vary based on the transmitting frequency. For example, the width of a beam may be inversely related to the frequency, where the beamwidth may decrease as the transmitting frequency increases because more radiating elements may be placed per given area at a transmitter due to smaller wavelength. As a result, higher frequency bands (e.g., THz or sub-THz frequency bands) may enable wireless devices to form much narrower beam structures (e.g., pencil beams, laser beams, or narrow beams, among other examples) compared to the beam structures under the FR2 or below because more radiating elements may be placed per given area at the antenna element due to smaller wavelength. The higher frequency bands may have short delay spreads (e.g., a few nanoseconds) and may be translated into coherence frequency bandwidths of tens (10s) of MHz. In addition, the higher frequency bands may provide a large available bandwidth, which may be occupied by larger bandwidth carriers, such as 1000 MHz per carrier or above. In some examples, the transmission path of a narrower beam may be more likely to be tailored to a receiver, such that the transmission may be more likely to meet a line-of-sight (LOS) condition as the narrower beam may be more likely to reach the receiver without being obstructed by obstacle(s). Also, as the transmission path may be narrow, reflection and/or refraction may be less likely to occur for the narrower beam.

While higher frequency bands may provide narrower beam structures and higher transmission rates, higher frequency bands may also encounter higher attenuation and diffraction losses, where a blockage of an LOS path may degrade a wireless link quality. For example, when two wireless devices are communicating with each other based on an LOS path at a higher frequency band and the LOS path is blocked by an obstacle, such as a pedestrian, building, and/or vehicle, among other examples, the received power may drop significantly. As a result, wireless communications based on higher frequency bands may be more susceptible to environmental changes compared to lower frequency bands. To ensure that the UE 120 and the network node 110 are communicating using a best beam or beam pair, beam management procedures (e.g., such as the beam management procedures described in connection with FIG. 3) may be performed by the UE 120 and/or the network node 110. However, because higher frequency bands may be more susceptible to environmental changes compared to lower frequency bands, the beam management procedures may need to be performed more frequently and/or using additional beams. This may introduce significant overhead and consume network resources, processing resources, and/or power resources of a UE (and/or a network node) associated with performing the beam management procedures.

As indicated above, FIG. 3 is provided as an example of beam management procedures. Other examples of beam management procedures may differ from what is described with respect to FIG. 3. For example, the UE 120 and the network node 110 may perform the third beam management procedure before performing the second beam management procedure, and/or the UE 120 and the network node 110 may perform a similar beam management procedure to select a UE transmit beam.

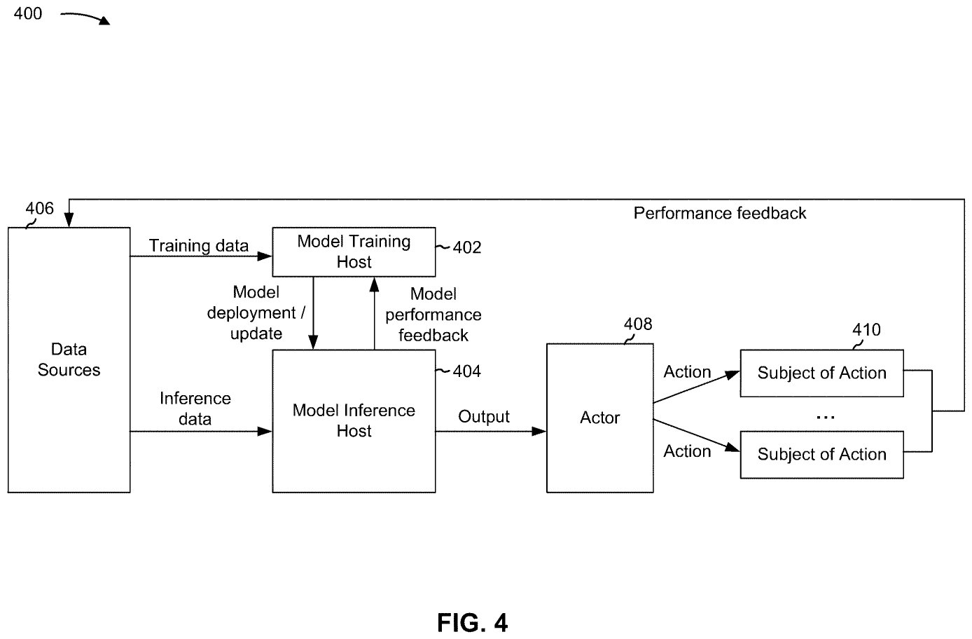

FIG. 4 is a diagram illustrating an example architecture 400 of a functional framework for RAN intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the AI functionality and/or the input/output of the component for AI enabled optimization) have been utilized or studied to identify the benefits of AI enabled RAN through possible use cases (e.g., beam management, energy saving, load balancing, mobility management, and/or coverage optimization, among other examples). In one example, as shown by the architecture 400, a functional framework for RAN intelligence may include multiple logical entities, such as a model training host 402, a model inference host 404, data sources 406, and an actor 408.

The model inference host 404 may be configured to run an AI/ML model based on inference data provided by the data sources 406, and the model inference host 404 may produce an output (e.g., a prediction) with the inference data input to the actor 408. The actor 408 may be an element or an entity of a core network or a RAN. For example, the actor 408 may be a UE, a network node, base station (e.g., a gNB), a CU, a DU, and/or an RU, among other examples. In addition, the actor 408 may also depend on the type of tasks performed by the model inference host 404, type of inference data provided to the model inference host 404, and/or type of output produced by the model inference host 404. For example, if the output from the model inference host 404 is associated with beam management, the actor 408 may be a UE, a DU or an RU; whereas if the output from the model inference host 404 is associated with Tx/Rx scheduling, the actor 408 may be a CU or a DU.

After the actor 408 receives an output from the model inference host 404, the actor 408 may determine whether to act based on the output. For example, if the actor 408 is a DU or an RU and the output from the model inference host 404 is associated with beam management, the actor 408 may determine whether to change/modify a Tx/Rx beam based on the output. If the actor 408 determines to act based on the output, the actor 408 may indicate the action to at least one subject of action 410. For example, if the actor 408 determines to change/modify a Tx/Rx beam for a communication between the actor 408 and the subject of action 410 (e.g., a UE 120), then the actor 408 may transmit a beam (re-)configuration or a beam switching indication to the subject of action 410. The actor 408 may modify its Tx/Rx beam based on the beam (re-)configuration, such as switching to a new Tx/Rx beam or applying different parameters for a Tx/Rx beam, among other examples. As another example, the actor 408 may be a UE and the output from the model inference host 404 may be associated with beam management. For example, the output may be one or more predicted measurement values for one or more beams. The actor 408 (e.g., a UE) may determine that a measurement report (e.g., an L1 RSRP report) is to be transmitted to a network node 110.

The data sources 406 may also be configured for collecting data that is used as training data for training an ML model or as inference data for feeding an ML model inference operation. For example, the data sources 406 may collect data from one or more core network and/or RAN entities, which may include the subject of action 410, and provide the collected data to the model training host 402 for ML model training. For example, after a subject of action 410 (e.g., a UE 120) receives a beam configuration from the actor 408, the subject of action 410 may provide performance feedback associated with the beam configuration to the data sources 406, where the performance feedback may be used by the model training host 402 for monitoring or evaluating the ML model performance, such as whether the output (e.g., prediction) provided to the actor 408 is accurate. In some examples, if the output provided by the actor 408 is inaccurate (or the accuracy is below an accuracy threshold), then the model training host 402 may determine to modify or retrain the ML model used by the model inference host, such as via an ML model deployment/update.

As indicated above, FIG. 4 is provided as an example. Other examples may differ from what is described with regard to FIG. 4.

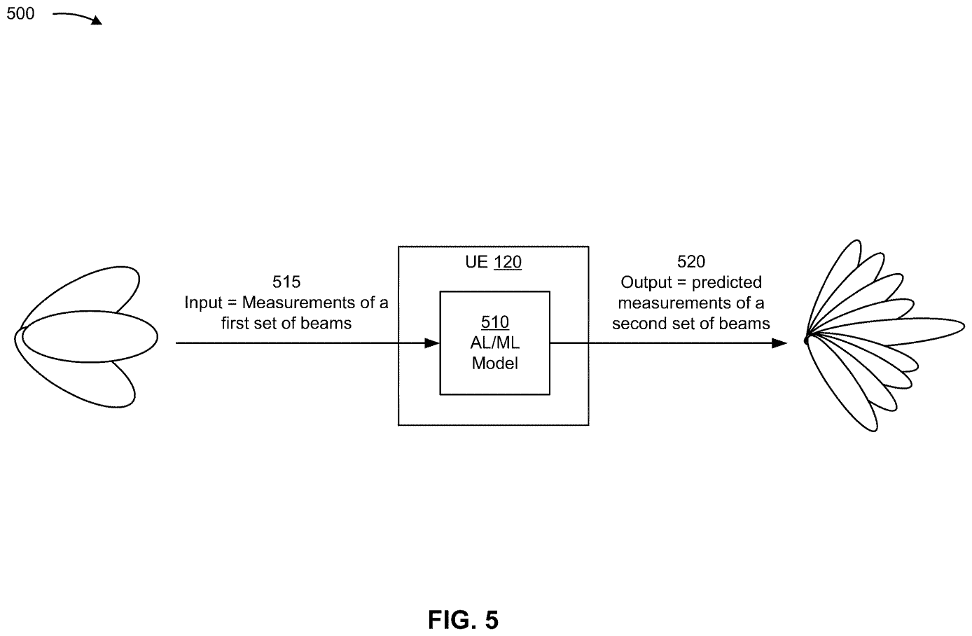

FIG. 5 is a diagram illustrating an example 500 of an AI/ML based beam management, in accordance with the present disclosure. As shown in FIG. 5, an AI/ML model 510 may be deployed at or on a UE 120. For example, a model inference host (such as a model inference host 404) may be deployed at, or on, a UE 120. The AI/ML model 510 may enable the UE 120 to determine one or more inferences or predictions based on data input to the AI/ML model 510.

For example, as shown by reference number 515, an input to the AI/ML model 510 may include measurements associated with a first set of beams. For example, a network node 110 may transmit one or more signals via respective beams from the first set of beams. The UE 120 may perform measurements (e.g., L1 RSRP measurements or other measurements) of the first set of beams to obtain a first set of measurements. For example, each beam, from the first set of beams, may be associated with one or more measurements performed by the UE 120. The UE 120 may input the first set of measurements (e.g., L1 RSRP measurement values) into the AI/ML model 510 along with information associated with the first set of beams and/or a second set of beams, such as a beam direction (e.g., spatial direction), beam width, beam shape, and/or other characteristics of the respective beams from the first set of beams and/or the second set of beams.

As shown by reference number 520, the AI/ML model 510 may output one or more predictions. The one or more predictions may include predicted measurement values (e.g., predicted L1 RSRP measurement values) associated with the second set of beams. This may reduce a quantity of beam measurements that are performed by the UE 120, thereby conserving power of the UE 120 and/or network resources that would have otherwise been used to measure all beams included in the first set of beams and the second set of beams. This type of prediction may be referred to as a codebook-based spatial domain selection or prediction.

As another example, an output of the AI/ML model 510 may include a point-direction, an angle of departure (AoD), and/or an angle of arrival (AoA) of a beam included in the second set of beams. This type of prediction may be referred to as a non-codebook-based spatial domain selection or prediction. As another example, multiple measurement reports or values, collected at different points in time, may be input to the AI/ML model 510. This may enable the AI/ML model 510 to output codebook-based and/or non-codebook-based predictions for a measurement value, an AoD, and/or an AoA, among other examples, of a beam at a future time. The output(s) of the AI/ML model 510, as described herein, may facilitate initial access procedures, secondary cell group (SCG) setup procedures, beam refinement procedures (e.g., a P2 beam management procedure or a P3 beam management procedure as described above in connection with FIG. 4), link quality or interference adaptation procedures, beam failure and/or beam blockage predictions, and/or radio link failure predictions, among other examples.

In some examples, beam measurement predictions may be performed by a UE (e.g., as depicted in FIG. 5) and/or by a network node 110 in a similar manner as described above. For example, a network node 110 may receive one or more measurements (e.g., performed by a UE 120) and may use an AI/ML model 510 to predict one or more measurements (e.g., of other beams) based on or otherwise in accordance with the one or more measurements performed by the UE 120. For example, predictions may be performed by a network node 110 because the network node 110 may have more processing resources and/or a greater processing capability than a UE 120. Additionally, the network node 110 may have access to historical measurement reports and/or measurement reports from other UEs that may be used as inputs to the AI/ML model 510 (e.g., which may improve an accuracy of an output of the AI/ML model 510). Predictions may be performed by the UE 120 because the UE 120 may have access to filtered measurements of all beams (e.g., not all measurements may be reported to the network node 110). Additionally, the UE 120 may have information related to the receive beam(s) used to derive or perform the measurements (e.g., which may be a useful input for the AI/ML model 510). As another example, the measurement information at the UE 120 may be “raw” or non-quantized, thereby providing more information that can be input into the AI/ML model 510. Further, the UE 120 may have knowledge of an orientation or a rotational position of the UE 120.

In some examples, the first set of beams (e.g., that are measured) may be referred to as Set B beams and the second set of beams (e.g., that are associated with predicted measurements) may be referred to as Set A beams. In some examples, the first set of beams (e.g., the Set B beams) may be a subset of the second set of beams (e.g., the Set A beams). In some other examples, the first set of beams and the second set of beams may be different beams and/or may be mutually exclusive sets. For example, the first set of beams (e.g., the Set B beams) may include wide beams (e.g., unrefined beams or beams having a beam width that satisfies a first threshold) and the second set of beams (e.g., the Set A beams) may include narrow beams (e.g., refined beams or beams having a beam width that satisfies a second threshold). In one example, the AI/ML model 510 may perform spatial-domain downlink beam predictions for beams included in the Set A beams based on measurement results of beams included in the Set B beams. As another example, the AI/ML model 510 may perform temporal downlink beam prediction for beams included in the Set A beams based on historic measurement results of beams included in the Set B beams.

In some examples, beams included in the first set of beams (e.g., the Set B beams) may be fixed over time and/or may follow a set or predictable pattern. For example, at various time domain measurement occasions, beams included in the first set of beams (e.g., the Set B beams to be measured by the UE 120 to facilitate a prediction of measurements of the Set A beams) may be fixed (e.g., the same) or may follow a set pattern. For example, the Set A beams may include 16 beams and the Set B beams may be a subset of the Set A beams. In some examples, at each time domain measurement occasion, the Set B beams may be the same subset of the Set A beams. In other examples, the set B beams may change at different time domain measurement occasions, but may follow a set or predictable pattern, such as a round-robin pattern.

In examples in which the UE 120 performs the beam measurement predictions (e.g., the AI/ML model 510 is deployed at the UE 120), the network node 110 may determine the selection of Set B beams to be measured by the UE 120. In some examples, using a fixed set of Set B beams over time may degrade a performance of predictions made by the AI/ML model 510 (e.g., that is deployed at the UE 120). For example, one or more beams included in the Set B beams may be associated with a beam blockage, interference, or another intervening factor that degrades performances of signals communicated via the one or more beams. For example, higher frequency bands may encounter higher attenuation and diffraction losses, where a blockage of an LOS path may degrade a wireless link quality. Therefore, using a fixed set of Set B beams over time may result in inaccurate or degraded performance of predicting measurements for beams included in the Set A. In some examples, the network node 110 may determine a pattern for varying the Set B beams over different time domain measurement occasions. For example, the network node 110 may indicate, to the UE 120, a semi-random pattern for selecting the Set B beams over different time domain measurement occasions or different CMR sets associated with different time domain measurement occasions. In some examples, information may be available at the UE 120 (such as information relating to a mobility of the UE 120, an orientation of the UE 120, a position of the UE 120, and/or a capability of the UE 120, among other examples) that could improve the selection of the Set B beams and result in increased accuracy of the predicted measurements of the Set A beams. However, such information may not be available at the network node 110, and thus is not used by the network node 110 to determine the selection of the Set B beams.

Some techniques and apparatuses described herein enable UE recommendation of CMRs in UE-based beam prediction. In some aspects, a UE may receive, from a network node, configuration information indicating one or more CPRs associated with a CSI report. The configuration may also indicate first CMRs to be used for predicting measurements for the CPRs. For example, the CPRs may correspond to a set of Set A beams, and the first CMRs may correspond to a first set of Set B beams. The UE may perform measurements (e.g., L1 RSRP measurements) for the first CMRs, and the UE may predict measurement values for the CPRs (e.g., using an AI/ML model deployed at the UE). The UE may transmit, to the network node, a CSI report including the predicted measurement values for the CPRs, and the UE may transmit, to the network node, an indication of one or more second CMRs to be used for predicting measurements for the CPRs. For example, the second CMRs may be CMRs recommended by the UE (e.g., CMRs corresponding to a set of recommended Set B beams) to be used by the UE for predicting the measurements for the CPRs in one or more subsequent time domain measurement occasions.

As a result, the UE may recommend CMRs (e.g., corresponding to Set B beams) to be used for predicting measurements for the CPRs (e.g., corresponding to Set A beams). By providing an indication of recommended CMRs to be used for beam measurement prediction, the described techniques can be used to improve the selection of Set B beams, resulting in increased accuracy of beam measurement predictions for the Set A beams.

As indicated above, FIG. 5 is provided as an example. Other examples may differ from what is described with regard to FIG. 5.

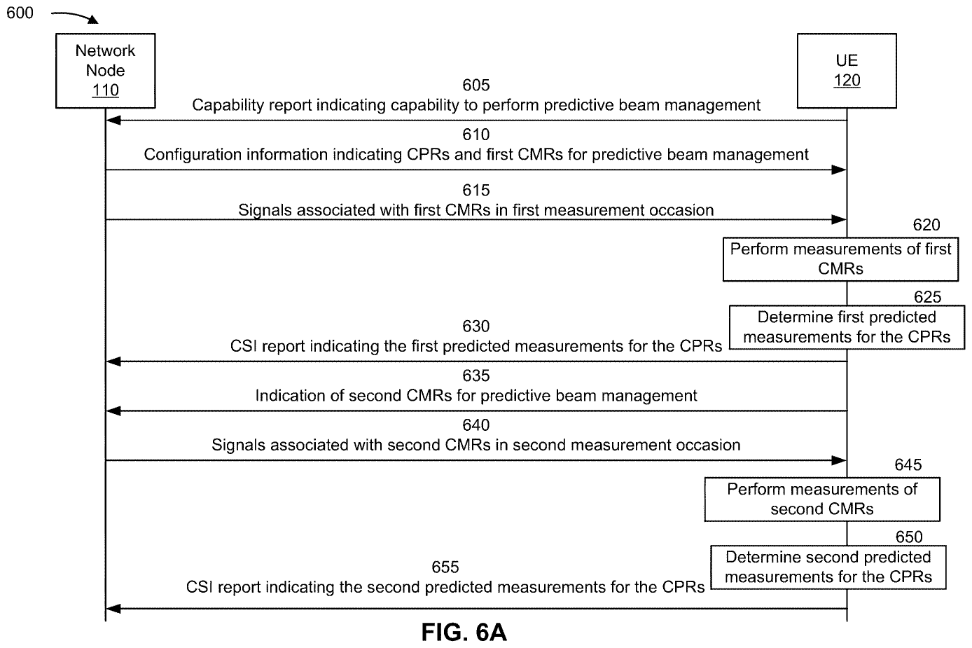

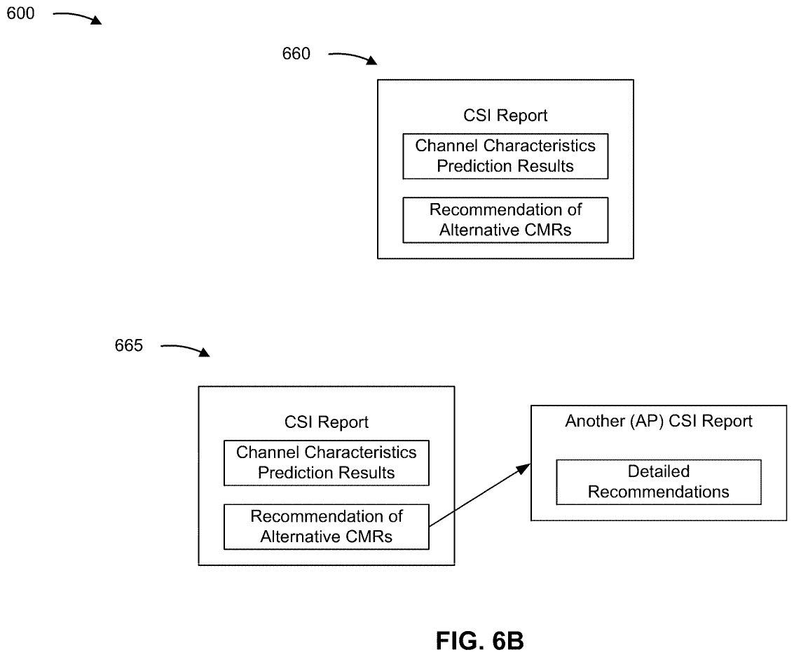

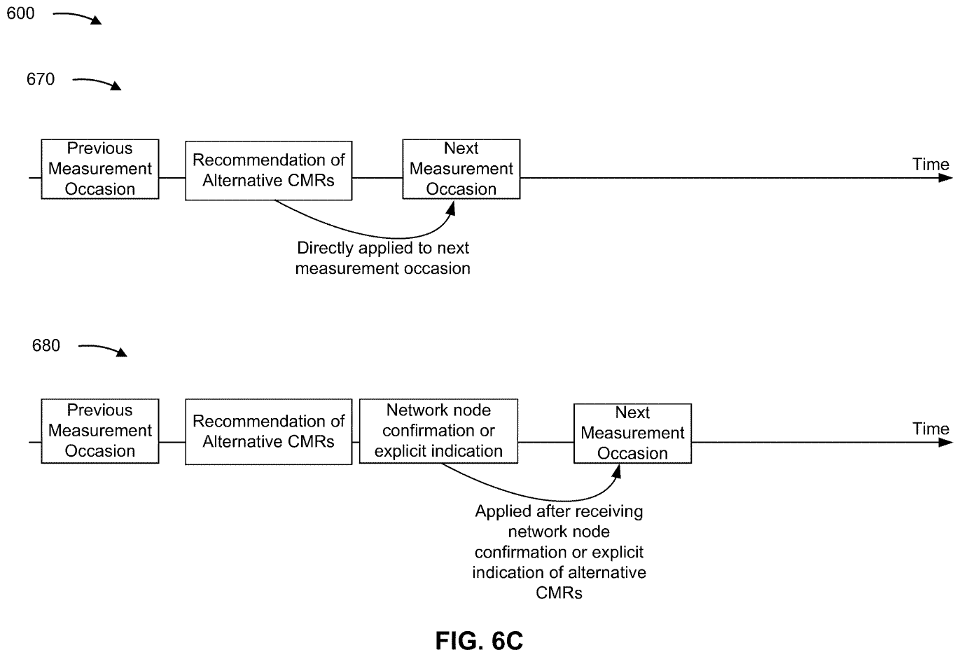

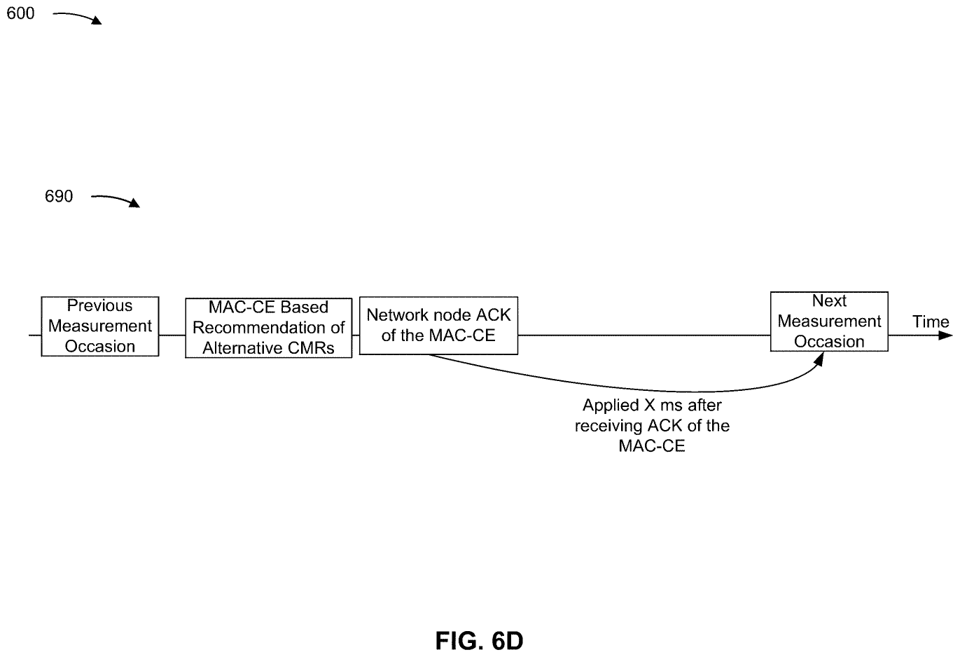

FIGS. 6A-6D are diagrams illustrating an example 600 associated with UE recommendation of CMRs in UE-based beam prediction, in accordance with the present disclosure. As shown in FIG. 6A, a network node 110 (e.g., a base station, a CU, a DU, and/or an RU) may communicate with a UE 120. In some aspects, the network node 110 and the UE 120 may be part of a wireless network (e.g., the wireless network 100). The UE 120 and the network node 110 may have established a wireless connection prior to operations shown in FIG. 6A.

In some aspects, actions described herein as being performed by a network node 110 may be performed by multiple different network nodes. For example, configuration actions may be performed by a first network node (for example, a CU or a DU), and radio communication actions may be performed by a second network node (for example, a DU or an RU). As used herein, the network node 110 “transmitting” a communication to the UE 120 may refer to a direct transmission (e.g., from the network node 110 to the UE 120) or an indirect transmission via one or more other network nodes or devices. For example, if the network node 110 is a DU, an indirect transmission to the UE 120 may include the DU transmitting a communication to an RU and the RU transmitting the communication to the UE 120. Similarly, the UE 120 “transmitting” a communication to the network node 110 may refer to a direct transmission (e.g., from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU.

As shown in FIG. 6A, and by reference number 605, the UE 120 may transmit, and the network node 110 may receive, a capability report. The capability report may indicate that the UE 120 supports performing predictive beam management, as described herein. For example, the capability report may indicate that the UE 120 supports performing one or more operations as described in connection with FIGS. 4 and 5. In some aspects, the capability report may indicate that the UE 120 supports recommending CMRs to be measured for predictive beam management, as described in more detail elsewhere herein. In some aspects, the UE 120 may be configured to perform one or more operations described herein based on or otherwise associated with the capability report indicating that the UE 120 supports performing predictive beam management.

As further shown in FIG. 6A, and by reference number 610, the network node 110 may transmit, and the UE 120 may receive, configuration information. In some aspects, the UE 120 may receive the configuration information via one or more of system information signaling, RRC signaling, one or more MAC-CEs, and/or DCI, among other examples. In some aspects, the configuration information may include an indication of one or more configuration parameters (e.g., already stored by the UE 120 and/or previously indicated by the network node 110 or other network device) for selection by the UE 120, and/or explicit configuration information for the UE 120 to use to configure itself, among other examples.

In some aspects, the configuration information may indicate that the UE 120 is to perform predictive beam management. For example, the configuration information may indicate that the UE 120 is to use an AI/ML model and/or a model inference host deployed at, or associated with, the UE 120 to predict measurement values (e.g., L1 RSRP values, L1 signal-to-interference-plus-noise ratio (SINR) values, CQIs, rank indicators (RIs), precoding matrix indicators (PMIs), layer indications (LIs), and/or other values or parameters) associated with one or more beams (e.g., Set A beams). For example, the configuration information may indicate that the UE 120 is to predict measurement values associated with transmit beam(s) of the network node 110 (e.g., of an RU) using measurement value(s) (e.g., obtained by the UE 120) of other transmit beam(s) of the network node 110.

In some aspects, the configuration information may indicate one or more CPRs associated with a CSI report. The CPRs may be associated with the beams (e.g., the Set A beams) for which measurement values are to be predicted by the UE 120 (e.g., using the AI/ML model) and reported in the CSI report. For example, each CPR may be associated with a respective beam for which one or more predicted measurement values are to be reported in the CSI report. In some aspects, the one or more CPRs may include virtual resources associated with beams on which signals are not actually transmitted by the network node 110 in a time domain measurement occasion associated with CSI reporting. Additionally or alternatively, the one or more CPRs may include one or more CMRs on which signals (e.g., downlink reference signals) are transmitted by the network node 110 in the time domain measurement occasion. For example, the CPRs may include downlink reference signal resources, such as SSB resources or CSI-RS resources, among other examples. In some aspects, the configuration information may indicate that the UE 120 is to include, in the CSI report, predicted measurements for one or more channel characteristics (e.g., L1 RSRP and/or L1 SINR, among other examples) or an indication of a top K resources (e.g., in terms of predicted L1 RSRP and/or L1 SINR, among other examples) of the CPRs associated with the CSI report. In some aspects, the configuration information may indicate one or more sets of CPRs for which predicted measurement values are to be reported in the CSI report. For example, the different sets of CPRs may be associated with different CMRs used to predict the measurement values for the CPRs.

In some aspects, the configuration information may indicate one or more first CMRs associated with the CSI report. The first CMRs may be CMRs to be used for predicting the measurements for the CPRs. The first CMRs may include downlink reference signal resources, such as SSB resources or CSI-RS resources, among other examples. The first CMRs may be associated with beams (e.g., the Set B beams) to be measured in a time domain measurement occasion associated with the CSI report. For example, each first CMR may be associated with a respective beam for which one or more measurements (e.g., L1 RSRP measurements and/or L1 SINR measurements, among other examples) are to be performed in the time domain measurement occasion. The first CMRs may be initial or default CMRs configured for predicting the measurements of the one or more CPRs. In some aspects, the one or more first CMRs may be a subset of the CPRs for which the predicted measurement values are to be reported.

In some aspects, the configuration information may include a CSI configuration. For example, the configuration information may include a CSI report setting and/or a CSI resource setting, among other examples. As another example, the configuration information may include a CSI-ReportConfig configuration and/or a CSI-ResourceConfig configuration, among other examples. In other words, the configuration information may configure the UE 120 to transmit a CSI report including information (e.g., the predicted measurements) associated with the one or more CPRs. In some aspects, the configuration information may indicate a report quantity configuration for the CSI report. For example, the UE 120 may be configured with a CSI-ReportConfig with the higher layer parameter reportQuantity set to either none, cri-RI-PMI-CQI, cri-RI-i1, cri-RI-i1-CQI, cri-RI-CQI, cri-RSRP, ssb-Index-RSRP, or cri-RI-LI-PMI-CQI, among other examples (for example, as defined, or otherwise fixed, by the 3GPP). The report quantity may indicate or configure what measurement values (e.g., predicted measurement values) are to be included in the CSI report, or what the UE 120 is to expected to be configured with for the CSI report, among other examples. In other words, the report quantity may indicate what kind of quantity (e.g., SSB RSRP, CQI, PMI, and/or RI) should be measured and reported by the UE 120. For example, the UE 120 may receive a configuration (e.g., a CSI report setting, a CSI resource setting, a CSI-ReportConfig, and/or a CSI-ResourceConfig) for the CSI report. The configuration may indicate the one or more CPRs associated with the CSI report and the one or more first CMRs to be used to predict the measurement values for the one or more CPRs.

In some aspects, the configuration information may indicate a fixed set of first CMRs to be measured in different time domain measurement occasions and used to predict the measurement values for the CPRs. In some other aspects, the configuration information may indicate first CMRs that vary across different time domain measurement occasions based on or otherwise associated with a CMR pattern. For example, the configuration information may indicate a random seed associated with a cycling formula that is used to determine the CMR pattern for varying the first CMRs across time domain measurement occasions. In such examples, the cycling formula may be separately configured by the network node 110 (e.g., indicated in other configuration information transmitted by the network node 110 and received by the UE 120), or the cycling formula may be defined in a wireless communication standard, such as a 3GPP standard.

In some aspects, the configuration information associated with the CSI report may indicate multiple options (e.g., candidate CMRs and/or candidate CMR sets) for the first CMRs and/or a CMR pattern associated with the first CMRs. In such examples, the network node 110 may transmit, and the UE 120 may receive, an indication of a selected option for the first CMRs and/or the CMR pattern associated with the first CMRs. In some examples, the configuration information associated with the CSI report may include the indication of the selected option for the first CMRs and/or the CMR pattern. In some other examples, the indication of the selected option may be included in a separate communication (e.g., an RRC message, a MAC-CE, or DCI) from the configuration information indicating the multiple options for the first CMRs and/or the CMR pattern.

For example, the network node 110 may transmit, and the UE 120 may receive, a MAC-CE that indicates the selected option to activate one or more first CMRs or a CMR pattern associated with the first CMRs (e.g., for semi-persistent CSI reports).

In some aspects, the configuration information may indicate an AI/ML model to be used by the UE 120 for predictive beam management. For example, the UE 120 may download the AI/ML model from the network (e.g., from the network node 110). In some aspects, the AI/ML model may be trained by the network node 110 and provided to the UE 120. In other aspects, the UE 120 may train the AI/ML model. In some aspects, the AI/ML model may be pre-configured (e.g., in an original equipment manufacturer (OEM) configuration) on the UE 120. In some aspects, the configuration information may indicate one or more inputs to be provided to the AI/ML model, such as one or more measurement values, a CMR pattern, and/or QCL information of the one or more CMRs that are measured by the UE 120, among other aspects. In some aspects, the configuration information may indicate one or more outputs to be provided by the AI/ML model, such as predicted L1 RSRP values, predicted L1 SINR values, predicted CQIs, predicted RIs, predicted PMIs, predicted LIs, and/or other predicted values or parameters associated with the one or more CPRs.

In some aspects, the configuration information may configure the UE 120 to recommend alternative CMRs to be used in place of the first CMRs for predicting the measurement values for the CPRs. In some aspects, the configuration information may indicate multiple candidate CMRs and/or CMR sets. The candidate CMRs and/or CMR sets may be candidates for the CMRs to be used for predicting measurement values of CPRs. In some examples, the configuration information may configure one or more candidate CMR sets, and different candidate CMR sets may include the same quantity of CMRs or different quantities of CMRs. In some examples, each of the one or more candidate CMR sets may be associated with a corresponding CPR set for which measurement values are to be predicted using the measurements of the CMRs in the candidate CMR set. In some aspects, each of the one or more candidate CMR sets may be associated with a CMR set identifier (ID), and the CMRs within a candidate CMR set may be associated with respective CMR IDs. In some aspects, the configuration may indicate multiple candidate UE recommendation options, and each candidate UE recommendation option may correspond to a respective combination of one or more CMRs of the candidate CMRs. In such examples, each candidate UE recommendation option may be associated with a respective ID, and different candidate UE recommendation options may include the same quantity of CMRs or different quantities of CMRs. In such examples, the UE 120 may be configured to recommend alternative CMRs to be used instead of the first CMRs by indicating a UE recommendation option of the candidate UE recommendation options (e.g., using the ID associated with the UE recommendation option).

In some aspects, the configuration information may configure the UE 120 to recommend alternative CMRs to be used instead of the first CMRs by indicating Type D quasi co-location (TypeD-QCL) reference sources associated with the alternative CMRs. In such examples, the configuration information may indicate candidate TypeD-QCL reference sources (e.g., associated with respective TypeD-QCL reference source IDs) that may be indicated by the UE 120. Additionally or alternatively, the configuration information may indicate multiple candidate UE recommendation options, each corresponding to a respective combination of one or more TypeD-QCL reference sources of the candidate TypeD-QCL reference sources. In some aspects, the candidate TypeD-QCL reference sources may be associated with downlink reference signals (e.g., SSBs and/or CSI-RSs) actually transmitted by the network node 110 and/or uplink reference signals (e.g., sounding reference signals (SRSs)) transmitted to the network node 110. In some aspects, the candidate TypeD-QCL reference sources may be associated with downlink AoA and/or AoD values, or other virtual angle quantities.

In some aspects, the configuration information may indicate and/or configure associations between beam pointing directions, beam widths, and/or beamforming gains of the candidate CMRs and the CPRs. In some examples, the associations between the beam pointing directions, beam widths, and/or beamforming gains of the candidate CMRs and the CPRs may be configured by explicitly indicating such beam parameters in the configuration information. In some other examples, the associations between the beam pointing directions, beam widths, and/or beamforming gains of the candidate CMRs and the CPRs may be configured based on or otherwise associated with indications of relative beam pointing directions (e.g., which resource is next to which azimuth/elevation) in the configuration information, without indicating more beamforming pattern details.

The UE 120 may configure itself based on or otherwise associated with the configuration information. In some aspects, the UE 120 may be configured to perform one or more operations described herein based on or otherwise associated with the configuration information.

As further shown in FIG. 6A, and by reference number 615, the network node 110 may transmit, and the UE 120 may receive, one or more signals associated with the one or more first CMRs in a first time domain measurement occasion associated with the CSI report. For example, the network node 110 may transmit downlink reference signals (e.g., SSBs and/or CSI-RSs) using resources associated with the first CMRs. In some aspects, the network node 110 may only transmit signals (e.g., downlink reference signals) using the first CMRs (e.g., the initial or default CMRs) in the first time domain measurement occasion. In other words, the network node 110 may only transmit signals via the configured Set B beams (e.g., the initial or default Set B beams) in the first time domain measurement occasion. In some other aspects, the network node 110 may transmit signals (e.g., downlink reference signals) using resources in addition to the first CMRs. For example, the network node 110 may transmit signals on all or a subset of the Set A beams (e.g., using resources associated with all or a subset of the CPRs).

As further shown in FIG. 6A, and by reference number 620, the UE 120 may perform measurements of the first CMRs in the first time domain measurement occasion. The UE 120 may perform measurements of the signals associated with the first CMRs.

For example, the UE 120 may perform L1 RSRP measurements, L1 SINR measurements, CQI measurements, RI measurements, PMI measurements, and/or LI measurements, among other examples, of the signals that are associated with the first CMRs. In some aspects, in an example in which the network node 110 transmits signals using resources in addition to the first CMRs in the first time domain measurement occasion, the UE 120 may only perform the measurements of the signals transmitted using the first CMRs in the first time domain measurement occasion.

As further shown in FIG. 6A, and by reference number 625, the UE 120 may determine first predicted measurements for the CPRs associated with the CSI report using (e.g., based on or otherwise associated with) the measurements of the first CMRs. For example, the UE 120 may input the measurements of the first CMRs to an AI/ML model. In some examples, the UE 120 may also input other information, such as an indication of the first CMRs, the CMR pattern used to determine the first CMRs, or beam/spatial/quasi co-location (QCL) information associated with the first CMRs, among other examples, to the AI/ML model. The AI/ML model may output first predicted measurement values or parameters associated with the CPRs, as described in more detail elsewhere herein. In some aspects, the prediction may be based on or otherwise associated with measurements performed at a single time domain measurement occasion (e.g., the measurements of the first CMRs performed in the first time domain measurement occasion). In other aspects, the prediction may be based on or otherwise in accordance with measurements performed at multiple time domain measurement occasions (e.g., the UE 120 may input measurements performed at multiple time domain measurement occasions, including the measurements of the first CMRs in the first time domain measurement occasion, into the AI/ML model to obtain the first predicted measurement values for the CPRs).

As further shown in FIG. 6A, and by reference number 630, the UE 120 may transmit, and the network node 110 may receive, a CSI report (e.g., a first CSI report) indicating the first predicted measurements for the CPRs. For example, the CSI report may include the first predicted measurement values, associated with the CPRs, determined by the UE 120 using (e.g., based on or otherwise associated with) the measurements of the first CMRs. In some aspects, the CSI report may include the predicted measurement values for all of the CPRs associated with the CSI report. In some other aspects, the CSI report may include predicted measurement values for a subset of the CPRs associated with the CSI report, such as for a top quantity (e.g., K) of CPRs determined based on or otherwise associated with the predicted measurement values for the CPRs (e.g., the K CPRs with the highest predicted L1 RSRP or L1 SINR values). In some aspects, the CSI report may include the first predicted measurement values associated with the CPRs, and the CSI may also include measurement values for all or a subset of the first CMRs.

As further shown in FIG. 6A, and by reference number 635, the UE 120 may transmit, and the network node 110 may receive, an indication of one or more second CMRs for predictive beam management (e.g., one or more second CMRs to be used for predicting measurement values for the CPRs). The one or more second CMRs may include one or more recommended alternative CMRs to be used (e.g., instead of one or more of the first CMRs) for predicting measurements for the CPRs. That is, the indication of the one or more second CMRs may be a recommendation, provided by the UE 120, of alternative CMRs to be used for predicting measurements for the CPRs in one or more subsequent time domain measurement occasions associated with the CSI report. The second CMRs may be associated with recommended Set B beams to be measured for predicting Set A beams. In some aspects, the UE 120 may determine the one or more second CMRs (e.g., the recommended alternative CMRs) based on or otherwise associated with information relating to mobility of the UE 120, an orientation of the UE 120, a position of the UE 120, and/or a capability of the UE 120, among other examples. Such information may be available to the UE 120, but not to the network node 110. For example, the UE 120 may recommend, based on or otherwise associated with the information, one or more alternative CMRs (e.g., the one or more second CMRs) to improve accuracy of the predicted measurement values for the CPRs.

In some aspects, the indication of the one or more second CMRs may be included in the CSI report (e.g., the first CSI report) that indicates the first predicted measurement values associated with the CPRs. For example, the UE 120 may report a recommendation of alternative CMRs (e.g., the second CMRs) via the same CSI report (e.g., the first CSI report) that carries the prediction results for the CPRs that are determined based on or otherwise associated with the measurements of the first CMRs.

In such examples, the CSI report (e.g., the first CSI report) may include a direct recommendation (e.g., an explicit indication) of the one or more second CMRs recommended for predicting measurements for the CPRs to be reported in one or more subsequent CSI reports. For example, as shown in FIG. 6B, and by reference number 660, the CSI report may include the channel characteristic prediction results (e.g., the first predicted measurement values based on or otherwise associated with the measurements of the first CMRs in the first time domain measurement occasion) and a recommendation of alternative CMRs (e.g., the indication of the one or more CMRs).

In some examples, the indication of the second CMRs in the CSI report may explicitly report information identifying each CMR (e.g., each recommended CMR) of the second CMRs. For example, the indication of the second CMRs in the CSI report may include a respective indication of a CMR ID associated with each CMR of the one or more second CMRs. In another example, if multiple candidate CMR sets are configured in the configuration information, the indication of the second CMRs in the CSI report may include, for each CMR of the one or more second CMRs, a respective indication of a CMR set ID that identifies a CMR set, of the multiple candidate CMR sets, and a respective indication of a CMR identifier that identifies the CMR within the CMR set. In such examples in which information explicitly identifying each of the second CMRs is included in the CSI report, the configuration information may configure the total quantity of recommended CMRs to be indicated in the CSI report.

In some other examples, the configuration information may indicate multiple candidate CMR sets, and the indication of the second CMRs in the CSI report may include an indication of a CMR set identifier associated with a CMR set of the multiple candidate CMR sets. In such examples, the UE 120 indicates a recommended CMR set of the multiple candidate CMRs. Different candidate CMR sets may include the same quantity of CMRs or different quantities of CMRs.

In some other examples, the configuration information may indicate multiple configured UE recommendation options for candidate CMRs, and each UE recommendation option, of the multiple configured UE recommendation options, may correspond to a respective combination of one or more CMRs of the candidate CMRs. In such examples, the indication of the second CMRs in the CSI report may include an indication of an ID associated with a UE recommendation option of the multiple configured UE recommendation options. For example, different configured UE recommendation options may include the same quantity of CMRs or different quantities of CMRs.

In some examples, the indication of the second CMRs in the CSI report may include an indication of one or more TypeD-QCL reference sources associated with the one or more second CMRs (e.g., an indication of one or more recommended TypeD-QCL reference sources). For example, the one or more TypeD-QCL reference sources may be associated with one or more downlink or uplink reference signals, or the one or more TypeD-QCL reference sources may be associated with one or more downlink AoA or AoD values or other virtual angle quantities. In some examples, the configuration information may indicate multiple candidate TypeD-QCL reference sources, and the indication of the one or more TypeD-QCL reference sources in the CSI report may include, for each CMR of the one or more second CMRs, a respective indication of a TypeD-QCL reference source ID associated with a candidate TypeD-QCL reference source of the plurality of candidate TypeD-QCL reference sources.

In some other examples, the configuration information may indicate multiple configured UE recommendation options for candidate TypeD-QCL reference sources, and each UE recommendation option, of the multiple configured UE recommendation options, may correspond to a respective combination of one or more of the candidate TypeD-QCL reference sources. In such examples, the indication of the one or more TypeD-QCL reference sources in the CSI report may include an indication of an ID associated with a UE recommendation option of the multiple configured UE recommendation options. For example, different configured UE recommendation options may include the same quantity of candidate TypeD-QCL reference sources or different quantities of candidate TypeD-QCL reference sources.

In some aspects, the CSI report (e.g., the first CSI report) that indicates the first predicted measurement values associated with the CPRs may include an indication of a recommendation to change CMRs to be used for predicting measurements for the CPRs, and the indication of the one or more second CMRs (e.g., the recommended alternative CMRs) may be included in an aperiodic CSI report triggered in connection with the indication of the recommendation to change the CMRs. For example, as shown in FIG. 6B, and by reference number 665, the CSI report (e.g., the first CSI report) may include the channel characteristic prediction results (e.g., the first predicted measurement values based on or otherwise associated with the measurements of the first CMRs in the first time domain measurement occasion) and an indication of a recommendation of whether to change one or more of the CMRs to be used for predicting the measurements of the CPRs (e.g., a recommendation of whether to change one or more of the first CMRs). In connection with the CSI report (e.g., the first CSI report) indicating a recommendation to change one or more of the CMRs, another CSI report (e.g., an aperiodic CSI report) may be triggered, and a detailed recommendation of the recommended changes to the CMRs (e.g., the indication of the one or more second CMRs) may be included in the other CSI report (e.g., the aperiodic CSI report). For example, the UE 120 may indicate in the first CSI report whether or not the UE 120 recommends any changes to the first CMRs used for predicting the measurements for the CPRs. The network node 110, in connection with receiving an indication of a recommendation to change one or more CMRs in the first CSI report, may transmit, to the UE 120, an indication triggering the aperiodic CSI report. The UE 120 may receive the indication triggering the aperiodic CSI reportion, and the UE 120 may transmit the aperiodic CSI report including (e.g., in a payload of the aperiodic CSI report) the indication of the one or more CMRs (e.g., one or more alternative CMRs recommended by the UE 120).

In some examples, the first CSI report may include a one-bit indication of whether the UE 120 recommends changing any of the currently measured CMRs used for predicting measurements for the CPRs (e.g., any of the first CMRs) to alternative CMRs. For example, a first value (e.g., 1) for the one-bit indication may indicate a recommendation to change the CMRs, and a second value (e.g., 0) for the one-bit indication may indicate a recommendation not to change the CMRs. In such examples, the network node 110 may trigger the aperiodic CSI report (e.g., by transmitting the indication triggering the aperiodic CSI report) in connection with the one-bit indication in the first CSI report indicating the first value. The payload of the aperiodic CSI report may include the indication of the one or more second CMRs. For example, the one or more second CMRs (or one or more TypeD-QCL reference sources associated with the one or more second CMRs) may be indicated in the aperiodic CSI report in a similar manner as described above in connection with the first CSI report.

In some other examples, the first CSI report may include a bitmap that indicates whether the UE 120 recommends changing one or more of the currently measured CMRs used for predicting measurements for the CPRs (e.g., one or more of the first CMRs) to alternative CMRs. The bitmap may include bits corresponding to the first CMRs. For example, the bitmap may include a respective bit corresponding to each first CMR of the one or more first CMRs. Each bit of the bitmap may indicate whether the UE 120 recommends changing the corresponding first CMR to an alternative CMR. For example, a first value (e.g., 1) for a bit of the bitmap may indicate a recommendation to change the corresponding first CMR, and a second value (e.g., 0) for a bit of the bitmap may indication a recommendation not to change the corresponding first CMR. Accordingly, the bitmap may indicate which of the first CMRs the UE 120 recommends changing. In such examples, the network node 110 may trigger the aperiodic CSI report in connection with the bitmap indicating a recommendation to change one or more of the first CMRs (e.g., in connection with one or more bits of the bitmap indicating the first value). The payload size of the aperiodic CSI report may be based on or otherwise associated with the number of bits, of the bitmap, indicating the first value. For example, the indication of the one or more second CMRs in the payload of the aperiodic CSI report may indicate a respective second CMR for each first CMR for which the respective bit of the bitmap indicates the first value. For example, the second CMRs may be indicated in the aperiodic CSI report using respective CMR IDs and/or respective CMR set IDs, or TypeD-QCL reference sources associated the second CMRs may be indicated in the aperiodic CSI report using respective TypeD-QCL reference source IDs.

In some other examples, the first CSI report may include an indication of a quantity of the first CMRs recommended to be changed. For example, the UE 120 may indicate, in the first CSI report, the quantity of first CMRs that the UE 120 recommends changing. In such examples, the network node 110 may trigger the aperiodic CSI report in connection with the first CSI report indicating a quantity of one or more first CMRs recommended to be changed. In such examples, the payload of the aperiodic CSI report may include an indication of each of the first CMRs recommended to be changed and an indication of a respective second CMR for each of the first CMRs recommended to be changed.

In some aspects, the indication of the one or more second CMRs (e.g., the recommended alternative CMRs for predicting the measurements of the CPRs) may be included in a MAC-CE. For example, the UE 120 may transmit, and the network node 110 may receive, a MAC-CE including the indication of the one or more second CMRs. In such examples, the UE 120 may report alternative CMRs (e.g., the second CMRs) recommended to be measured for one or more time domain measurement occasions or alternative TypeD-QCL reference sources associated with the alternative CMRs (e.g., TypeD-QCL reference sources associated with the second CMRs) in a payload of the MAC-CE.

In some examples, the indication of the second CMRs in the MAC-CE may include information explicitly identifying each CMR (e.g., each recommended CMR) of the second CMRs. For example, the indication of the second CMRs in the MAC-CE may include a respective indication of a CMR ID associated with each CMR of the one or more second CMRs. In another example, if multiple candidate CMR sets are configured in the configuration information, the indication of the second CMRs in the MAC-CE may include, for each CMR of the one or more second CMRs, a respective indication of a CMR set ID that identifies a CMR set, of the multiple candidate CMR sets, and a respective indication of a CMR identifier that identifies the CMR within the CMR set. In some other examples, the configuration information may indicate multiple candidate CMR sets, and the indication of the second CMRs in the MAC-CE may include an indication of a CMR set ID associated with a CMR set of the multiple candidate CMR sets. In some other examples, the configuration information may indicate multiple configured UE recommendation options for candidate CMRs, and each UE recommendation option, of the multiple configured UE recommendation options, may correspond to a respective combination of one or more CMRs of the candidate CMRs. In such examples, the indication of the second CMRs in the MAC-CE may include an indication of an ID associated with a UE recommendation option of the multiple configured UE recommendation options.

In some examples, the indication of the second CMRs in the MAC-CE may include an indication of one or more TypeD-QCL reference sources associated with the one or more second CMRs (e.g., an indication of one or more recommended TypeD-QCL reference sources). In some examples, the configuration information may indicate multiple candidate TypeD-QCL reference sources, and the indication of the one or more TypeD-QCL reference sources in the MAC-CE may include, for each CMR of the one or more second CMRs, a respective indication of a TypeD-QCL reference source ID associated with a candidate TypeD-QCL reference source of the multiple candidate TypeD-QCL reference sources. In some other examples, the configuration information may indicate multiple configured UE recommendation options for candidate TypeD-QCL reference sources, and each UE recommendation option, of the multiple configured UE recommendation options, may correspond to a respective combination of one or more of the candidate TypeD-QCL reference sources. In such examples, the indication of the one or more TypeD-QCL reference sources in the MAC-CE may include an indication of an ID associated with a UE recommendation option of the multiple configured UE recommendation options.

In some aspects, the CMRs (or TypeD-QCL reference sources associated with the CMRs) to be used for predicting measurements for the CPRs may be varied across consecutive time domain measurement occasions based on or otherwise associated with a certain pattern. For example, the configuration information may indicate a first CMR pattern for varying CMRs to be used for predicting measurements of the CPRs across multiple time domain measurement occasions, and the first CMRs measured in the first time domain measurement occasion may be determined based on or otherwise associated with the first CMR pattern. In such examples, the UE 120 may recommend an alternative CMR pattern that is different from the current CMR pattern (e.g., the first CMR pattern). For example, the indication of the one or more second CMRs (e.g., included in the MAC-CE, the first CSI report, or the aperiodic CSI report) may include an indication of a second CMR pattern for varying CMRs to be used for predicting measurements of the CPRs across multiple time domain measurement occasions. In such examples, the network node 110 and the UE 120 may determine the one or more second CMRs to be transmitted by the network node 110 and measured by the UE 120 in a second time domain measurement occasion based on or otherwise associated with the second CMR pattern. In some examples, the configuration information may indicate a first random seed associated with a cycling formula that is used to determine the first CMR pattern. In such examples, the indication of the one or more second CMRs (e.g., included in the MAC-CE, the first CSI report, or the aperiodic CSI report) may include an indication of a second random seed (e.g., an alternative random seed to the first random seed) to be used with the cycling formula to determine the second CMR pattern.

In some aspects, the indication of the one or more second CMRs (e.g., included in the MAC-CE, the first CSI report, or the aperiodic CSI report) may include an indication of a recommended time duration associated with the one or more second CMRs (or the recommended TypeD-QCL reference sources associated with the second CMRs). For example, the indication of the recommended time duration may be an indication of a recommended number of upcoming time domain measurement occasions for which the recommended CMRs (e.g., the one or more second CMRs) or the recommended TypeD-QCL reference sources (e.g., the TypeD-QCL reference sources associated with the second CMRs) are to be used. In some examples, the UE 120 recommended time duration may be a recommendation for a time duration (e.g., a number of time domain measurement occasions) for which the second CMRs are to be used for predicting the measurements of the CPRs, and after which the first CMRs (e.g., the initial or default CMRs) are to be used again for predicting the measurement of the CPRs.

Returning to FIG. 6A, as shown by reference number 640, the network node 110 may transmit, and the UE 120 may receive, one or more signals associated with the one or more second CMRs in a first time domain measurement occasion associated with the CSI report. For example, the network node 110 may transmit downlink reference signals (e.g., SSBs and/or CSI-RSs) using resources associated with the second CMRs. In some aspects, the network node 110 may only transmit signals (e.g., downlink reference signals) using the second CMRs (e.g., the CMRs recommended by the UE 120) in the second time domain measurement occasion. In other words, the network node 110 may only transmit signals via the Set B beams recommended by the UE 120 (e.g., the Set B beams associated with the second CMRs) in the second time domain measurement occasion. In some other aspects, the network node 110 may transmit signals (e.g., downlink reference signals) using resources in addition to the second CMRs. For example, the network node 110 may transmit signals on all or a subset of the Set A beams (e.g., using resources associated with all or a subset of the CPRs).

As further shown in FIG. 6A, and by reference number 645, the UE 120 may perform measurements of the second CMRs in the second time domain measurement occasion. The UE 120 may perform measurements of the signals associated with the second CMRs. For example, the UE 120 may perform L1 RSRP measurements, L1 SINR measurements, CQI measurements, RI measurements, PMI measurements, and/or LI measurements, among other examples, of the signals that are associated with the second CMRs. In some aspects, in an example in which the network node 110 transmits signals using resources in addition to the second CMRs in the second time domain measurement occasion, the UE 120 may only perform the measurements of the signals transmitted using the second CMRs in the second time domain measurement occasion.

In some aspects, the UE 120 may perform the measurements of the second CMRs in the second time domain measurement occasion based on or otherwise associated with transmitting the indication of the one or more second CMRs to the network node 110. In some aspects, the network node 110 may transmit the signals associated with the second CMRs in the second time domain measurement occasion based on or otherwise associated with receiving the indication of the one or more second CMRs from the UE 120. In some examples, the timing of the second time domain measurement occasion, in which the network node 110 transmits the signals associated with the second CMRs and the UE 120 performs the measurements of the second CMRs (e.g., in which the network node 110 and the UE 120 switch from using the first CMRs to the second CMRs), may be based on or otherwise associated with the transmission of the indication of the one or more second CMRs from the UE 120 to the network node 110. Additionally or alternatively, the timing of the second time domain measurement occasion may be based on or otherwise associated with a communication transmitted from the network node 110 to the UE 120 subsequent to the transmission of the indication of the one or more second CMRs from the UE 120 to the network node 110.

FIG. 6C shows examples 670 and 680 associated with applying alternative CMRs recommended by the UE 120. In examples 670 and 680, the UE 120 may transmit a recommendation of alternative CMRs (e.g., the second CMRs) to the network node 110 after measuring the first CMRs (e.g., initial or default CMRs) in a previous measurement occasion. For example, the recommendation of the alternative CMRs (e.g., the indication of the second CMRs) may be included in the CSI report that includes predicted measurement values determined using the measurements of the first CMRs in the previous measurement occasion, an aperiodic CSI report, or a MAC-CE, as described elsewhere herein. As shown in example 670, in some aspects, the recommended alternative CMRs may be applied to the next measurement occasion after the UE 120 transmits the recommendation of the alternative CMRs to the network node 110 (e.g., without any further confirmation from the network node 110). For example, the UE 120 may measure the recommended alternative CMRs starting in the next measurement occasion after the UE 120 transmits the recommendation of the alternative CMRs to the network node 110. For instance, in an example in which the UE 120 transmits the recommendation of the alternative CMRs in a CSI report, the UE 120 may expect to be measuring the recommended alternative CMRs in the next measurement occasion after the CSI report carrying the details CMR recommendations is transmitted. In such examples, the network node 110 may transmit the signals associated with the recommended alternative CMRs in the next measurement occasion after the network node 110 receives the recommendation of the alternative CMRs from the UE 120.

As shown in example 680, in some aspects, the network node 110 may transmit, and the UE 120 may receive, a confirmation of the recommended alternative CMRs or an explicit indication changing the CMRs to be measured to the recommended alternative CMRs, and the change to the recommended alternative CMRs may be applied to a next measurement occasion after the UE 120 receives the confirmation or the explicit indication of the recommended alternative CMRs. In such examples, the UE 120 may await further confirmation of the recommended CMRs from the network node 110 (or explicit signaling on changing the CMRs) before measuring the recommended CMRs. In some examples, the explicit signaling from the network node 110 on changing the CMRs may include a reconfiguration and/or a reactivation of the CMRs to be measured. The confirmation or explicit signaling transmitted by the network node 110 may lead to a different number of CMRs being measured in the next measurement occasion (after the UE 120 receives the confirmation or explicit signaling), as compared to the previous measurement occasion (e.g., provided that recommending variable numbers of CMRs is supported by the UE 120).

FIG. 6D shows another example 690 associated with applying alternative CMRs recommended by the UE 120. In example 690, the UE 120 may transmit a MAC-CE based recommendation of alternative CMRs (e.g., a MAC-CE including the indication of the one or more second CMRs) to the network node 110 after measuring the first CMRs (e.g., initial or default CMRs) in a previous measurement occasion. As shown in example 690, in some aspects, the network node 110 may transmit, and the UE 120 may receive, an acknowledgement (ACK) of the MAC-CE in connection with the network node 110 receiving the MAC-CE including the recommendation of the alternative CMRs, and the recommended alternative CMRs may be applied to a next measurement occasion after a time offset (e.g., X ms) from the UE 120 receiving the ACK. For example, the UE 120 may expect that the CMRs (or the TypeD-QCL reference sources associated with the CMRs) to be measured are changed to the recommended alternative CMRs reported in the MAC-CE X ms after the UE 120 receives the ACK of the MAC-CE from the network node 110. For example, the value of X may be configured by the network node 110 (e.g., in the configuration information) or may be defined in a wireless communication standard (e.g., a 3GPP standard). In such examples, the network node 110 may transmit the signals associated with the recommended alternative CMRs, and the UE 120 may perform the measurements of the recommended alternative CMRs in the next measurement occasion after X ms from the UE 120 receiving the ACK.

Returning to FIG. 6A, as shown by reference number 650, the UE 120 may determine second predicted measurements for the CPRs associated with the CSI report using (e.g., based on or otherwise associated with) the measurements of the second CMRs. For example, the UE 120 may input the measurements of the second CMRs to the AI/ML model. In some examples, the UE 120 may also input other information, such as an indication of the second CMRs, a second CMR pattern used to determine the second CMRs, or beam/spatial/QCL information associated with the second CMRs, among other examples, to the AI/ML model. The AI/ML model may output second predicted measurement values or parameters associated with the CPRs, as described in more detail elsewhere herein. In some aspects, the prediction may be based on or otherwise associated with measurements performed at a single time domain measurement occasion (e.g., the measurements of the second CMRs performed in the second time domain measurement occasion). In other aspects, the prediction may be based on or otherwise in accordance with measurements performed at multiple time domain measurement occasions (e.g., the UE 120 may input measurements performed at multiple time domain measurement occasions, including the measurements of the second CMRs in the second time domain measurement occasion, into the AI/ML model to obtain the second predicted measurement values for the CPRs).

As further shown in FIG. 6A, and by reference number 655, the UE 120 may transmit, and the network node 110 may receive, a CSI report (e.g., a second CSI report) indicating the second predicted measurements for the CPRs. For example, the CSI report may include the second predicted measurement values, associated with the CPRs, determined by the UE 120 using (e.g., based on or otherwise associated with) the measurements of the second CMRs. In some aspects, the CSI report may include second predicted measurement values for all of the CPRs associated with the CSI report. In some other aspects, the CSI report may include the second predicted measurement values for a subset of the CPRs associated with the CSI report, such as for a top quantity (e.g., K) of CPRs determined based on or otherwise associated with the second predicted measurement values for the CPRs (e.g., the K CPRs with the highest predicted L1 RSRP or L1 SINR values). In some aspects, the CSI report may include the second predicted measurement values associated with the CPRs, and the CSI may also include measurement values for all or a subset of the second CMRs.

As indicated above, FIGS. 6A-6D are provided as an example. Other examples may differ from what is described with regard to FIGS. 6A-6D.

FIG. 7 is a flowchart illustrating an example process 700 performed, for example, by a UE that supports UE recommendation of CMRs in UE-based beam prediction in accordance with the present disclosure. Example process 700 is an example where the UE (for example, UE 120) performs operations associated with UE recommendation of CMRs in UE-based beam prediction.

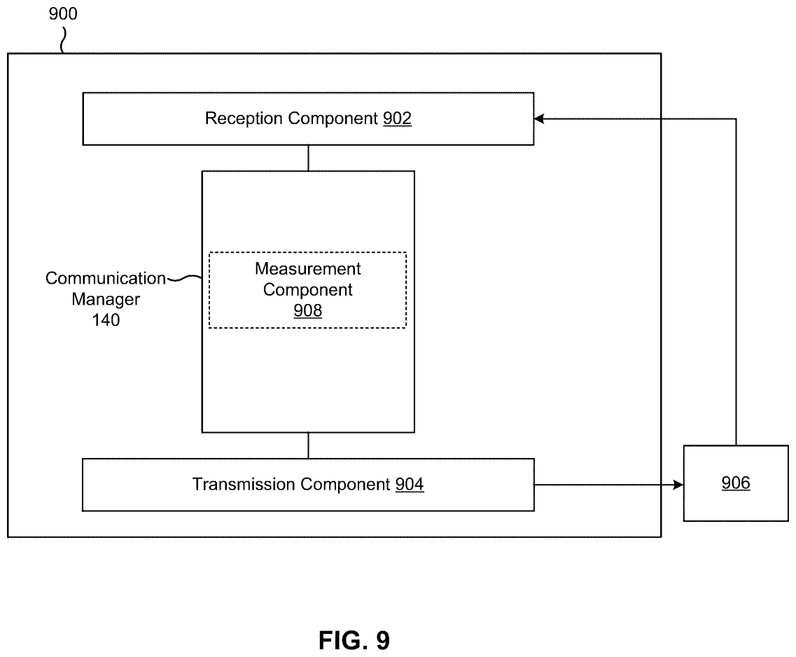

As shown in FIG. 7, in some aspects, process 700 may include receiving, from a network node, configuration information indicating one or more CPRs associated with a CSI report and one or more first CMRs to be used for predicting measurements for the one or more CPRs (block 710). For example, the UE (such as by using communication manager 140 or reception component 902, depicted in FIG. 9) may receive, from a network node, configuration information indicating one or more CPRs associated with a CSI report and one or more first CMRs to be used for predicting measurements for the one or more CPRs, as described above.

As further shown in FIG. 7, in some aspects, process 700 may include performing measurements of the one or more first CMRs (block 720). For example, the UE (such as by using communication manager 140 or measurement component 908, depicted in FIG. 9) may perform measurements of the one or more first CMRs, as described above.

As further shown in FIG. 7, in some aspects, process 700 may include transmitting, to the network node, a first CSI report including first predicted measurement values associated with the one or more CPRs, the first predicted measurement values in accordance with the measurements of the one or more first CMRs (block 730). For example, the UE (such as by using communication manager 140 or transmission component 904, depicted in FIG. 9) may transmit, to the network node, a first CSI report including first predicted measurement values associated with the one or more CPRs, the first predicted measurement values in accordance with the measurements of the one or more first CMRs, as described above.

As further shown in FIG. 7, in some aspects, process 700 may include transmitting, to the network node, an indication of one or more second CMRs to be used for predicting measurements for the one or more CPRs (block 740). For example, the UE (such as by using communication manager 140 or transmission component 904, depicted in FIG. 9) may transmit, to the network node, an indication of one or more second CMRs to be used for predicting measurements for the one or more CPRs, as described above.

Process 700 may include additional aspects, such as any single aspect or any combination of aspects described below or in connection with one or more other processes described elsewhere herein.

In a first additional aspect, process 700 includes performing measurements of the one or more second CMRs in association with transmitting the indication of the one or more second CMRs, and transmitting, to the network node, a second CSI report including second predicted measurement values associated with the one or more CPRs, the second predicted measurement values in accordance with the measurements of the one or more second CMRs.

In a second additional aspect, alone or in combination with the first aspect, transmitting the indication of the one or more second CMRs includes transmitting a MAC-CE including the indication of the one or more second CMRs.

In a third additional aspect, alone or in combination with one or more of the first and second aspects, process 700 includes receiving, from the network node, an acknowledgement of the MAC-CE, performing measurements of the one or more second CMRs in a next time domain measurement occasion after a time offset from receiving the acknowledgement, and transmitting, to the network node, a second CSI report including second predicted measurement values associated with the one or more CPRs, the second predicted measurement values in accordance with the measurements of the one or more second CMRs.

In a fourth additional aspect, alone or in combination with one or more of the first through third aspects, process 700 includes receiving, from the network node, a confirmation that the one or more second CMRs are to be used for predicting measurements for the one or more CPRs, performing measurements of the one or more second CMRs in a time domain measurement occasion subsequent to receiving the confirmation, and transmitting, to the network node, a second CSI report including second predicted measurement values associated with the one or more CPRs, the second predicted measurement values in accordance with the measurements of the one or more second CMRs.

In a fifth additional aspect, alone or in combination with one or more of the first through fourth aspects, process 700 includes performing measurements of the one or more second CMRs in a next time domain measurement occasion after transmitting the indication of the one or more second CMRs, and transmitting, to the network node, a second CSI report including second predicted measurement values associated with the one or more CPRs, the second predicted measurement values in accordance with the measurements of the one or more second CMRs.

In a sixth additional aspect, alone or in combination with one or more of the first through fifth aspects, the configuration information indicates a plurality of UE recommendation options for a plurality of CMRs, each UE recommendation option, of the plurality of UE recommendation options, corresponding to a respective combination of one or more CMRs of the plurality of CMRs, and the indication of the one or more second CMRs includes an indication of an identifier associated with a UE recommendation option of the plurality of UE recommendation options.

In a seventh additional aspect, alone or in combination with one or more of the first through sixth aspects, the configuration information indicates a plurality of CMR sets, and the indication of the one or more second CMRs includes an indication of a CMR set identifier associated with a CMR set of the plurality of CMR sets.

In an eighth additional aspect, alone or in combination with one or more of the first through seventh aspects, the configuration information indicates a plurality of CMR sets, and the indication of the one or more second CMRs includes, for each CMR of the one or more second CMRs, a respective indication of a CMR set identifier that identifies a CMR set, of the plurality of CMR sets, and a respective indication of a CMR identifier that identifies the CMR within the CMR set.

In a ninth additional aspect, alone or in combination with one or more of the first through eighth aspects, the indication of the one or more second CMRs includes a respective indication of a CMR identifier associated with each CMR of the one or more second CMRs.

In a tenth additional aspect, alone or in combination with one or more of the first through ninth aspects, the indication of the one or more second CMRs includes an indication of one or more TypeD-QCL reference sources associated with the one or more second CMRs.

In an eleventh additional aspect, alone or in combination with one or more of the first through tenth aspects, the configuration information indicates a plurality of candidate TypeD-QCL reference sources, and the indication of the one or more TypeD-QCL reference sources includes a respective indication of a candidate TypeD-QCL reference source, of the plurality of candidate TypeD-QCL reference sources, for each CMR of the one or more second CMRs.

In a twelfth additional aspect, alone or in combination with one or more of the first through eleventh aspects, the configuration information indicates a plurality of UE recommendation options for a plurality of candidate TypeD-QCL reference sources, each UE recommendation option, of the plurality of UE recommendation options, corresponding to a respective combination of one or more candidate TypeD-QCL reference sources of the plurality of candidate TypeD-QCL reference sources, and the indication of the one or more TypeD-QCL reference sources includes an indication of an identifier associated with a UE recommendation option of the plurality of UE recommendation options.

In a thirteenth additional aspect, alone or in combination with one or more of the first through twelfth aspects, the one or more TypeD-QCL reference sources are associated with one or more downlink or uplink reference signals.

In a fourteenth additional aspect, alone or in combination with one or more of the first through thirteenth aspects, the one or more TypeD-QCL reference sources are associated with one or more downlink AoA or AoD values.

In a fifteenth additional aspect, alone or in combination with one or more of the first through fourteenth aspects, the indication of the one or more second CMRs is included in the first CSI report.

In a sixteenth additional aspect, alone or in combination with one or more of the first through fifteenth aspects, the first CSI report includes an indication of a recommendation to change CMRs to be used to predict measurements for the CPRs, and the indication of the one or more second CMRs is included in an aperiodic CSI report triggered in connection with the indication of the recommendation to change the CMRs to be used to predict measurements for the CPRs.

In a seventeenth additional aspect, alone or in combination with one or more of the first through sixteenth aspects, process 700 includes receiving, from the network node, an indication triggering the aperiodic CSI report in connection with the indication of the recommendation to change the CMRs to be used to predict measurements for the CPRs.

In an eighteenth additional aspect, alone or in combination with one or more of the first through seventeenth aspects, the indication of the recommendation to change the CMRs includes a one-bit indication of the recommendation to change the CMRs to be used to predict measurements for the CPRs.

In a nineteenth additional aspect, alone or in combination with one or more of the first through eighteenth aspects, the indication of the recommendation to change the CMRs includes a bitmap including a respective bit corresponding to each first CMR of the one or more first CMRs, the respective bit corresponding to each first CMR indicates a first value in connection with a recommendation to change the first CMR or a second value in connection with a recommendation not to change the first CMR, and the indication of the one or more second CMRs includes an indication of a respective second CMR for each first CMR for which the respective bit corresponding to the first CMR indicates the first value.

In a twentieth additional aspect, alone or in combination with one or more of the first through nineteenth aspects, the indication of the recommendation to change the CMRs includes an indication of a quantity of first CMRs recommended to be changed of the one or more first CMRs, and the indication of the one or more second CMRs includes an indication of each the first CMRs recommended to be changed and an indication of a respective second CMR for each of the first CMRs recommended to be changed.

In a twenty-first additional aspect, alone or in combination with one or more of the first through twentieth aspects, the configuration information indicates a first CMR pattern for varying CMRs to be used for predicting measurements of the CPRs across multiple time domain measurement occasions, the one or more first CMRs are associated with the first CMR pattern, the indication of the one or more second CMRs includes an indication of a second CMR pattern for varying CMRs to be used for predicting measurements of the CPRs across multiple time domain measurement occasions, and the one or more second CMRs are associated with the second CMR pattern.

In a twenty-second additional aspect, alone or in combination with one or more of the first through twenty-first aspects, the indication of the one or more second CMRs includes an indication of a recommended time duration associated with the one or more second CMRs.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a flowchart illustrating an example process 800 performed, for example, by a network node that supports UE recommendation of CMRs in UE-based beam prediction in accordance with the present disclosure. Example process 800 is an example where the network node (for example, network node 110) performs operations associated with UE recommendation of CMRs in UE-based beam prediction.

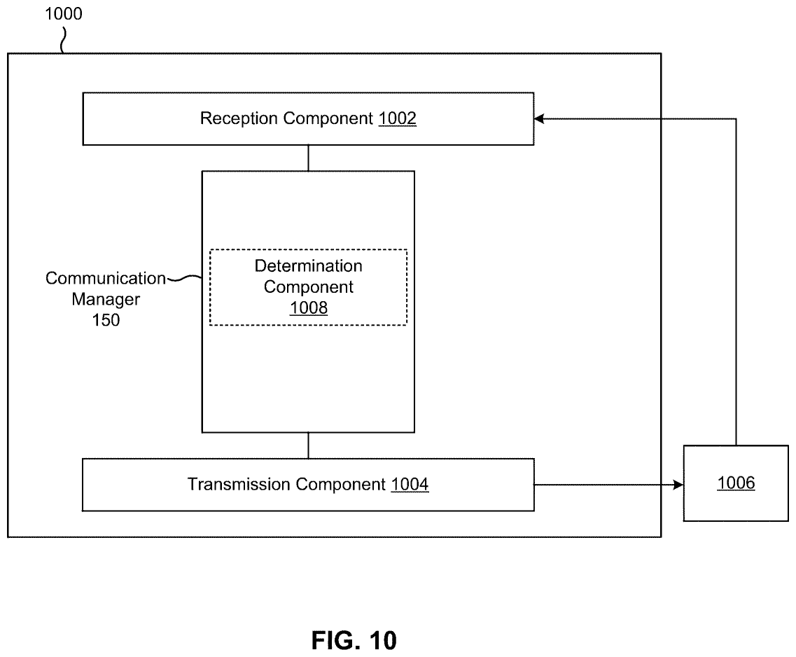

As shown in FIG. 8, in some aspects, process 800 may include transmitting, to a UE, configuration information indicating one or more CPRs associated with a CSI report and one or more first CMRs to be used for predicting measurements for the one or more CPRs (block 810). For example, the network node (such as by using communication manager 150 or transmission component 1004, depicted in FIG. 10) may transmit, to a UE, configuration information indicating one or more CPRs associated with a CSI report and one or more first CMRs to be used for predicting measurements for the one or more CPRs, as described above.

As further shown in FIG. 8, in some aspects, process 800 may include receiving, from the UE, a first CSI report including first predicted measurement values associated with the one or more CPRs, the first predicted measurement values in accordance with measurements of the one or more first CMRs (block 820). For example, the network node (such as by using communication manager 150 or reception component 1002, depicted in FIG. 10) may receive, from the UE, a first CSI report including first predicted measurement values associated with the one or more CPRs, the first predicted measurement values in accordance with measurements of the one or more first CMRs, as described above.

As further shown in FIG. 8, in some aspects, process 800 may include receiving, from the UE, an indication of one or more second CMRs to be used for predicting measurements for the one or more CPRs (block 830). For example, the network node (such as by using communication manager 150 or reception component 1002, depicted in FIG. 10) may receive, from the UE, an indication of one or more second CMRs to be used for predicting measurements for the one or more CPRs, as described above.

Process 800 may include additional aspects, such as any single aspect or any combination of aspects described below or in connection with one or more other processes described elsewhere herein.

In a first additional aspect, process 800 includes receiving, from the UE, a second CSI report including second predicted measurement values associated with the one or more CPRs, the second predicted measurement values in accordance with the measurements of the one or more second CMRs.

In a second additional aspect, alone or in combination with the first aspect, receiving the indication of the one or more second CMRs includes receiving a MAC-CE including the indication of the one or more second CMRs.

In a third additional aspect, alone or in combination with one or more of the first and second aspects, process 800 includes transmitting, to the UE, an acknowledgement of the MAC-CE, and receiving, from the UE, a second CSI report including second predicted measurement values associated with the one or more CPRs, the second predicted measurement values in accordance with the measurements of the one or more second CMRs in a time domain measurement occasion after a time offset from the acknowledgement.

In a fourth additional aspect, alone or in combination with one or more of the first through third aspects, process 800 includes transmitting, to the UE, a confirmation that the one or more second CMRs are to be used for predicting measurements for the one or more CPRs, and receiving, from the UE, a second CSI report including second predicted measurement values associated with the one or more CPRs, the second predicted measurement values in accordance with the measurements of the one or more second CMRs in a time domain measurement occasion subsequent to the confirmation.

In a fifth additional aspect, alone or in combination with one or more of the first through fourth aspects, the configuration information indicates a plurality of UE recommendation options for a plurality of CMRs, each UE recommendation option, of the plurality of UE recommendation options, corresponding to a respective combination of one or more CMRs of the plurality of CMRs, and the indication of the one or more second CMRs includes an indication of an identifier associated with a UE recommendation option of the plurality of UE recommendation options.

In a sixth additional aspect, alone or in combination with one or more of the first through fifth aspects, the configuration information indicates a plurality of CMR sets, and the indication of the one or more second CMRs includes an indication of a CMR set identifier associated with a CMR set of the plurality of CMR sets.

In a seventh additional aspect, alone or in combination with one or more of the first through sixth aspects, the configuration information indicates a plurality of CMR sets, and the indication of the one or more second CMRs includes, for each CMR of the one or more second CMRs, a respective indication of a CMR set identifier that identifies a CMR set, of the plurality of CMR sets, and a respective indication of a CMR identifier that identifies the CMR within the CMR set.

In an eighth additional aspect, alone or in combination with one or more of the first through seventh aspects, the indication of the one or more second CMRs includes a respective indication of a CMR identifier associated with each CMR of the one or more second CMRs.

In a ninth additional aspect, alone or in combination with one or more of the first through eighth aspects, the indication of the one or more second CMRs includes an indication of one or more TypeD-QCL reference sources associated with the one or more second CMRs.

In a tenth additional aspect, alone or in combination with one or more of the first through ninth aspects, the configuration information indicates a plurality of candidate TypeD-QCL reference sources, and the indication of the one or more TypeD-QCL reference sources includes a respective indication of a candidate TypeD-QCL reference source, of the plurality of candidate TypeD-QCL reference sources, for each CMR of the one or more second CMRs.

In an eleventh additional aspect, alone or in combination with one or more of the first through tenth aspects, the configuration information indicates a plurality of UE recommendation options for a plurality of candidate TypeD-QCL reference sources, each UE recommendation option, of the plurality of UE recommendation options, corresponding to a respective combination of one or more candidate TypeD-QCL reference sources of the plurality of candidate TypeD-QCL reference sources, and the indication of the one or more TypeD-QCL reference sources includes an indication of an identifier associated with a UE recommendation option of the plurality of UE recommendation options.

In a twelfth additional aspect, alone or in combination with one or more of the first through eleventh aspects, the one or more TypeD-QCL reference sources are associated with one or more downlink or uplink reference signals.

In a thirteenth additional aspect, alone or in combination with one or more of the first through twelfth aspects, the one or more TypeD-QCL reference sources are associated with one or more downlink AoA or AoD values.

In a fourteenth additional aspect, alone or in combination with one or more of the first through thirteenth aspects, the indication of the one or more second CMRs is included in the first CSI report.

In a fifteenth additional aspect, alone or in combination with one or more of the first through fourteenth aspects, the first CSI report includes an indication of a recommendation to change CMRs to be used to predict measurements for the CPRs, and the indication of the one or more second CMRs is included in an aperiodic CSI triggered in connection with the indication of the recommendation to change the CMRs to be used to predict measurements for the CPRs.

In a sixteenth additional aspect, alone or in combination with one or more of the first through fifteenth aspects, process 800 includes transmitting, to the UE, an indication triggering the aperiodic CSI report in connection with the indication of the recommendation to change the CMRs to be used to predict measurements for the CPRs.

In a seventeenth additional aspect, alone or in combination with one or more of the first through sixteenth aspects, the indication of the recommendation to change the CMRs includes a one-bit indication of the recommendation to change the CMRs to be used to predict measurements for the CPRs.

In an eighteenth additional aspect, alone or in combination with one or more of the first through seventeenth aspects, the indication of the recommendation to change the CMRs includes a bitmap including a respective bit corresponding to each first CMR of the one or more first CMRs, the respective bit corresponding to each first CMR indicates a first value in connection with a recommendation to change the first CMR or a second value in connection with a recommendation not to change the first CMR, and the indication of the one or more second CMRs includes an indication of a respective second CMR for each first CMR for which the respective bit corresponding to the first CMR indicates the first value.

In a nineteenth additional aspect, alone or in combination with one or more of the first through eighteenth aspects, the indication of the recommendation to change the CMRs includes an indication of a quantity of first CMRs recommended to be changed of the one or more first CMRs, and the indication of the one or more second CMRs includes an indication of each the first CMRs recommended to be changed and an indication of a respective second CMR for each of the first CMRs recommended to be changed.

In a twentieth additional aspect, alone or in combination with one or more of the first through nineteenth aspects, the configuration information indicates a first CMR pattern for varying CMRs to be used for predicting measurements of the CPRs across multiple time domain measurement occasions, the one or more first CMRs are associated with the first CMR pattern, the indication of the one or more second CMRs includes an indication of a second CMR pattern for varying CMRs to be used for predicting measurements of the CPRs across multiple time domain measurement occasions, and the one or more second CMRs are associated with the second CMR pattern.

In a twenty-first additional aspect, alone or in combination with one or more of the first through twentieth aspects, the indication of the one or more second CMRs includes an indication of a recommended time duration associated with the one or more second CMRs.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a diagram of an example apparatus 900 for wireless communication that supports UE recommendation of CMRs in UE-based beam prediction in accordance with the present disclosure. The apparatus 900 may be a UE, or a UE may include the apparatus 900. In some aspects, the apparatus 900 includes a reception component 902, a transmission component 904, and a communication manager 140, which may be in communication with one another (for example, via one or more buses). As shown, the apparatus 900 may communicate with another apparatus 906 (such as a UE, a network node, or another wireless communication device) using the reception component 902 and the transmission component 904.

In some aspects, the apparatus 900 may be configured to and/or operable to perform one or more operations described herein in connection with FIGS. 6A-6D.

Additionally or alternatively, the apparatus 900 may be configured to and/or operable to perform one or more processes described herein, such as process 700 of FIG. 7. In some aspects, the apparatus 900 may include one or more components of the UE described above in connection with FIG. 2.

The reception component 902 may receive communications, such as reference signals, control information, and/or data communications, from the apparatus 906. The reception component 902 may provide received communications to one or more other components of the apparatus 900, such as the communication manager 140. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 902 may include one or more antennas, a modem, a demodulator, a MIMO detector, a receive processor, a controller/processor, and/or a memory of the UE described above in connection with FIG. 2.

The transmission component 904 may transmit communications, such as reference signals, control information, and/or data communications, to the apparatus 906. In some aspects, the communication manager 140 may generate communications and may transmit the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, and/or a memory of the UE described above in connection with FIG. 2. In some aspects, the transmission component 904 may be co-located with the reception component 902 in a transceiver.

The communication manager 140 may receive or may cause the reception component 902 to receive, from a network node, configuration information indicating one or more CPRs associated with a CSI report and one or more first CMRs to be used for predicting measurements for the one or more CPRs. The communication manager 140 may perform measurements of the one or more first CMRs. The communication manager 140 may transmit or may cause the transmission component 904 to transmit, to the network node, a first CSI report including first predicted measurement values associated with the one or more CPRs, the first predicted measurement values in accordance with the measurements of the one or more first CMRs. The communication manager 140 may transmit or may cause the transmission component 904 to transmit, to the network node, an indication of one or more second CMRs to be used for predicting measurements for the one or more CPRs. In some aspects, the communication manager 140 may perform one or more operations described elsewhere herein as being performed by one or more components of the communication manager 140.

The communication manager 140 may include a controller/processor and/or a memory of the UE described above in connection with FIG. 2. In some aspects, the communication manager 140 includes a set of components, such as a measurement component 908. Alternatively, the set of components may be separate and distinct from the communication manager 140. In some aspects, one or more components of the set of components may include or may be implemented within a controller/processor and/or a memory of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive, from a network node, configuration information indicating one or more CPRs associated with a CSI report and one or more first CMRs to be used for predicting measurements for the one or more CPRs. The measurement component 908 may perform measurements of the one or more first CMRs. The transmission component 904 may transmit, to the network node, a first CSI report including first predicted measurement values associated with the one or more CPRs, the first predicted measurement values in accordance with the measurements of the one or more first CMRs. The transmission component 904 may transmit, to the network node, an indication of one or more second CMRs to be used for predicting measurements for the one or more CPRs.

The measurement component 908 may perform measurements of the one or more second CMRs in association with transmitting the indication of the one or more second CMRs. The transmission component 904 may transmit, to the network node, a second CSI report including second predicted measurement values associated with the one or more CPRs, the second predicted measurement values in accordance with the measurements of the one or more second CMRs.

The transmission component 904 may transmit a MAC-CE including the indication of the one or more second CMRs. The reception component 902 may receive, from the network node, an acknowledgement of the MAC-CE. The measurement component 908 may perform measurements of the one or more second CMRs in a next time domain measurement occasion after a time offset from receiving the acknowledgement. The transmission component 904 may transmit, to the network node, a second CSI report including second predicted measurement values associated with the one or more CPRs, the second predicted measurement values in accordance with the measurements of the one or more second CMRs.

The reception component 902 may receive, from the network node, a confirmation that the one or more second CMRs are to be used for predicting measurements for the one or more CPRs. The measurement component 908 may perform measurements of the one or more second CMRs in a time domain measurement occasion subsequent to receiving the confirmation. The transmission component 904 may transmit, to the network node, a second CSI report including second predicted measurement values associated with the one or more CPRs, the second predicted measurement values in accordance with the measurements of the one or more second CMRs.

The measurement component 908 may perform measurements of the one or more second CMRs in a next time domain measurement occasion after transmitting the indication of the one or more second CMRs.

The transmission component 904 may transmit, to the network node, a second CSI report including second predicted measurement values associated with the one or more CPRs, the second predicted measurement values in accordance with the measurements of the one or more second CMRs. The reception component 902 may receive, from the network node, an indication triggering the aperiodic CSI report in connection with the indication of the recommendation to change the CMRs to be used to predict measurements for the CPRs.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

FIG. 10 is a diagram of an example apparatus 1000 for wireless communication that supports UE recommendation of CMRs in UE-based beam prediction in accordance with the present disclosure. The apparatus 1000 may be a network node, or a network node may include the apparatus 1000. In some aspects, the apparatus 1000 includes a reception component 1002, a transmission component 1004, and a communication manager 150, which may be in communication with one another (for example, via one or more buses). As shown, the apparatus 1000 may communicate with another apparatus 1006 (such as a UE, a network node, or another wireless communication device) using the reception component 1002 and the transmission component 1004.

In some aspects, the apparatus 1000 may be configured to and/or operable to perform one or more operations described herein in connection with FIGS. 6A-6D. Additionally or alternatively, the apparatus 1000 may be configured to and/or operable to perform one or more processes described herein, such as process 800 of FIG. 8. In some aspects, the apparatus 1000 may include one or more components of the network node described above in connection with FIG. 2.

The reception component 1002 may receive communications, such as reference signals, control information, and/or data communications, from the apparatus 1006. The reception component 1002 may provide received communications to one or more other components of the apparatus 1000, such as the communication manager 150. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1002 may include one or more antennas, a modem, a demodulator, a MIMO detector, a receive processor, a controller/processor, and/or a memory of the network node described above in connection with FIG. 2.

The transmission component 1004 may transmit communications, such as reference signals, control information, and/or data communications, to the apparatus 1006. In some aspects, the communication manager 150 may generate communications and may transmit the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, and/or a memory of the network node described above in connection with FIG. 2. In some aspects, the transmission component 1004 may be co-located with the reception component 1002 in a transceiver.

The communication manager 150 may transmit or may cause the transmission component 1004 to transmit, to a UE, configuration information indicating one or more CPRs associated with a CSI report and one or more first CMRs to be used for predicting measurements for the one or more CPRs. The communication manager 150 may receive or may cause the reception component 1002 to receive, from the UE, a first CSI report including first predicted measurement values associated with the one or more CPRs, the first predicted measurement values in accordance with measurements of the one or more first CMRs. The communication manager 150 may receive or may cause the reception component 1002 to receive, from the UE, an indication of one or more second CMRs to be used for predicting measurements for the one or more CPRs. In some aspects, the communication manager 150 may perform one or more operations described elsewhere herein as being performed by one or more components of the communication manager 150.

The communication manager 150 may include a controller/processor, a memory, a scheduler, and/or a communication unit of the network node described above in connection with FIG. 2. In some aspects, the communication manager 150 includes a set of components, such as a determination component 1008. Alternatively, the set of components may be separate and distinct from the communication manager 150. In some aspects, one or more components of the set of components may include or may be implemented within a controller/processor, a memory, a scheduler, and/or a communication unit of the network node described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The transmission component 1004 may transmit, to a UE, configuration information indicating one or more CPRs associated with a CSI report and one or more first CMRs to be used for predicting measurements for the one or more CPRs. The reception component 1002 may receive, from the UE, a first CSI report including first predicted measurement values associated with the one or more CPRs, the first predicted measurement values in accordance with measurements of the one or more first CMRs. The reception component 1002 may receive, from the UE, an indication of one or more second CMRs to be used for predicting measurements for the one or more CPRs.

The determination component 1008 may determine the one or more CPRs and/or the one or more first CMRs.

The reception component 1002 may receive, from the UE, a second CSI report including second predicted measurement values associated with the one or more CPRs, the second predicted measurement values in accordance with the measurements of the one or more second CMRs.

The reception component 1002 may receive a MAC-CE including the indication of the one or more second CMRs. The transmission component 1004 may transmit, to the UE, an acknowledgement of the MAC-CE. The reception component 1002 may receive, from the UE, a second CSI report including second predicted measurement values associated with the one or more CPRs, the second predicted measurement values in accordance with the measurements of the one or more second CMRs in a time domain measurement occasion after a time offset from the acknowledgement.

The transmission component 1004 may transmit, to the UE, a confirmation that the one or more second CMRs are to be used for predicting measurements for the one or more CPRs. The reception component 1002 may receive, from the UE, a second CSI report including second predicted measurement values associated with the one or more CPRs, the second predicted measurement values in accordance with the measurements of the one or more second CMRs in a time domain measurement occasion subsequent to the confirmation.

The transmission component 1004 may transmit, to the UE, an indication triggering the aperiodic CSI report in connection with the indication of the recommendation to change the CMRs to be used to predict measurements for the CPRs.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed at a user equipment (UE), comprising: receiving, from a network node, configuration information indicating one or more channel prediction resources (CPRs) associated with a channel state information (CSI) report and one or more first channel measurement resources (CMRs) to be used for predicting measurements for the one or more CPRs; performing measurements of the one or more first CMRs; transmitting, to the network node, a first CSI report including first predicted measurement values associated with the one or more CPRs, the first predicted measurement values in accordance with the measurements of the one or more first CMRs; and transmitting, to the network node, an indication of one or more second CMRs to be used for predicting measurements for the one or more CPRs.
Aspect 2: The method of Aspect 1, further comprising: performing measurements of the one or more second CMRs in association with transmitting the indication of the one or more second CMRs; and transmitting, to the network node, a second CSI report including second predicted measurement values associated with the one or more CPRs, the second predicted measurement values in accordance with the measurements of the one or more second CMRs.
Aspect 3: The method of any of Aspects 1-2, wherein transmitting the indication of the one or more second CMRs comprises: transmitting a medium access control (MAC) control element (MAC-CE) including the indication of the one or more second CMRs.
Aspect 4: The method of Aspect 3, further comprising: receiving, from the network node, an acknowledgement of the MAC-CE; performing measurements of the one or more second CMRs in a next time domain measurement occasion after a time offset from receiving the acknowledgement; and transmitting, to the network node, a second CSI report including second predicted measurement values associated with the one or more CPRs, the second predicted measurement values in accordance with the measurements of the one or more second CMRs.
Aspect 5: The method of any of Aspects 1-3, further comprising: receiving, from the network node, a confirmation that the one or more second CMRs are to be used for predicting measurements for the one or more CPRs; performing measurements of the one or more second CMRs in a time domain measurement occasion subsequent to receiving the confirmation; and transmitting, to the network node, a second CSI report including second predicted measurement values associated with the one or more CPRs, the second predicted measurement values in accordance with the measurements of the one or more second CMRs.
Aspect 6: The method of any of Aspects 1-3, further comprising: performing measurements of the one or more second CMRs in a next time domain measurement occasion after transmitting the indication of the one or more second CMRs; and transmitting, to the network node, a second CSI report including second predicted measurement values associated with the one or more CPRs, the second predicted measurement values in accordance with the measurements of the one or more second CMRs.
Aspect 7: The method of any of Aspects 1-6, wherein the configuration information indicates a plurality of UE recommendation options for a plurality of CMRs, each UE recommendation option, of the plurality of UE recommendation options, corresponding to a respective combination of one or more CMRs of the plurality of CMRs, and wherein the indication of the one or more second CMRs includes an indication of an identifier associated with a UE recommendation option of the plurality of UE recommendation options.
Aspect 8: The method of any of Aspects 1-7, wherein the configuration information indicates a plurality of CMR sets, and wherein the indication of the one or more second CMRs includes an indication of a CMR set identifier associated with a CMR set of the plurality of CMR sets.
Aspect 9: The method of any of Aspects 1-8, wherein the configuration information indicates a plurality of CMR sets, and wherein the indication of the one or more second CMRs includes, for each CMR of the one or more second CMRs, a respective indication of a CMR set identifier that identifies a CMR set, of the plurality of CMR sets, and a respective indication of a CMR identifier that identifies the CMR within the CMR set.
Aspect 10: The method of any of Aspects 1-9, wherein the indication of the one or more second CMRs includes a respective indication of a CMR identifier associated with each CMR of the one or more second CMRs.
Aspect 11: The method of any of Aspects 1-10, wherein the indication of the one or more second CMRs includes an indication of one or more Type D quasi co-location (TypeD-QCL) reference sources associated with the one or more second CMRs.
Aspect 12: The method of Aspect 11, wherein the configuration information indicates a plurality of candidate TypeD-QCL reference sources, and wherein the indication of the one or more TypeD-QCL reference sources includes a respective indication of a candidate TypeD-QCL reference source, of the plurality of candidate TypeD-QCL reference sources, for each CMR of the one or more second CMRs.
Aspect 13: The method of any of Aspects 11-12, wherein the configuration information indicates a plurality of UE recommendation options for a plurality of candidate TypeD-QCL reference sources, each UE recommendation option, of the plurality of UE recommendation options, corresponding to a respective combination of one or more candidate TypeD-QCL reference sources of the plurality of candidate TypeD-QCL reference sources, and wherein the indication of the one or more TypeD-QCL reference sources includes an indication of an identifier associated with a UE recommendation option of the plurality of UE recommendation options.
Aspect 14: The method of any of Aspects 11-13, wherein the one or more TypeD-QCL reference sources are associated with one or more downlink or uplink reference signals.
Aspect 15: The method of any of Aspects 11-14, wherein the one or more TypeD-QCL reference sources are associated with one or more downlink angle of arrival (AoA) or angle of departure (AoD) values.
Aspect 16: The method of any of Aspects 1-2 and 5-15, wherein the indication of the one or more second CMRs is included in the first CSI report.
Aspect 17: The method of any of Aspects 1-2 and 5-15, wherein the first CSI report includes an indication of a recommendation to change CMRs to be used to predict measurements for the CPRs, and wherein the indication of the one or more second CMRs is included in an aperiodic CSI report triggered in connection with the indication of the recommendation to change the CMRs to be used to predict measurements for the CPRs.
Aspect 18: The method of Aspect 17, further comprising: receiving, from the network node, an indication triggering the aperiodic CSI report in connection with the indication of the recommendation to change the CMRs to be used to predict measurements for the CPRs.
Aspect 19: The method of any of Aspects 17-18, wherein the indication of the recommendation to change the CMRs includes a one-bit indication of the recommendation to change the CMRs to be used to predict measurements for the CPRs.
Aspect 20: The method of any of Aspects 17-18, wherein the indication of the recommendation to change the CMRs includes a bitmap including a respective bit corresponding to each first CMR of the one or more first CMRs, wherein the respective bit corresponding to each first CMR indicates a first value in connection with a recommendation to change the first CMR or a second value in connection with a recommendation not to change the first CMR, and wherein the indication of the one or more second CMRs includes an indication of a respective second CMR for each first CMR for which the respective bit corresponding to the first CMR indicates the first value.
Aspect 21: The method of any of Aspects 17-18, wherein the indication of the recommendation to change the CMRs includes an indication of a quantity of first CMRs recommended to be changed of the one or more first CMRs, and wherein the indication of the one or more second CMRs includes an indication of each the first CMRs recommended to be changed and an indication of a respective second CMR for each of the first CMRs recommended to be changed.
Aspect 22: The method of any of Aspects 1-21, wherein the configuration information indicates a first CMR pattern for varying CMRs to be used for predicting measurements of the CPRs across multiple time domain measurement occasions, wherein the one or more first CMRs are associated with the first CMR pattern, wherein the indication of the one or more second CMRs includes an indication of a second CMR pattern for varying CMRs to be used for predicting measurements of the CPRs across multiple time domain measurement occasions, and wherein the one or more second CMRs are associated with the second CMR pattern.
Aspect 23: The method of any of Aspects 1-22, wherein the indication of the one or more second CMRs includes an indication of a recommended time duration associated with the one or more second CMRs.
Aspect 24: A method of wireless communication performed at a network node, comprising: transmitting, to a user equipment (UE), configuration information indicating one or more channel prediction resources (CPRs) associated with a channel state information (CSI) report and one or more first channel measurement resources (CMRs) to be used for predicting measurements for the one or more CPRs; receiving, from the UE, a first CSI report including first predicted measurement values associated with the one or more CPRs, the first predicted measurement values in accordance with measurements of the one or more first CMRs; and receiving, from the UE, an indication of one or more second CMRs to be used for predicting measurements for the one or more CPRs.
Aspect 25: The method of Aspect 24, further comprising: receiving, from the UE, a second CSI report including second predicted measurement values associated with the one or more CPRs, the second predicted measurement values in accordance with the measurements of the one or more second CMRs.
Aspect 26: The method of any of Aspects 24-25, wherein receiving the indication of the one or more second CMRs comprises: receiving a medium access control (MAC) control element (MAC-CE) including the indication of the one or more second CMRs.
Aspect 27: The method of Aspect 26, further comprising: transmitting, to the UE, an acknowledgement of the MAC-CE; and receiving, from the UE, a second CSI report including second predicted measurement values associated with the one or more CPRs, the second predicted measurement values in accordance with the measurements of the one or more second CMRs in a time domain measurement occasion after a time offset from the acknowledgement.
Aspect 28: The method of any of Aspects 24-26, further comprising: transmitting, to the UE, a confirmation that the one or more second CMRs are to be used for predicting measurements for the one or more CPRs; and receiving, from the UE, a second CSI report including second predicted measurement values associated with the one or more CPRs, the second predicted measurement values in accordance with the measurements of the one or more second CMRs in a time domain measurement occasion subsequent to the confirmation.
Aspect 29: The method of any of Aspects 24-28, wherein the configuration information indicates a plurality of UE recommendation options for a plurality of CMRs, each UE recommendation option, of the plurality of UE recommendation options, corresponding to a respective combination of one or more CMRs of the plurality of CMRs, and wherein the indication of the one or more second CMRs includes an indication of an identifier associated with a UE recommendation option of the plurality of UE recommendation options.
Aspect 30: The method of any of Aspects 24-29, wherein the configuration information indicates a plurality of CMR sets, and wherein the indication of the one or more second CMRs includes an indication of a CMR set identifier associated with a CMR set of the plurality of CMR sets.
Aspect 31: The method of any of Aspects 24-30, wherein the configuration information indicates a plurality of CMR sets, and wherein the indication of the one or more second CMRs includes, for each CMR of the one or more second CMRs, a respective indication of a CMR set identifier that identifies a CMR set, of the plurality of CMR sets, and a respective indication of a CMR identifier that identifies the CMR within the CMR set.
Aspect 32: The method of any of Aspects 24-31, wherein the indication of the one or more second CMRs includes a respective indication of a CMR identifier associated with each CMR of the one or more second CMRs.
Aspect 33: The method of any of Aspects 24-32, wherein the indication of the one or more second CMRs includes an indication of one or more Type D quasi co-location (TypeD-QCL) reference sources associated with the one or more second CMRs.
Aspect 34: The method of Aspect 33, wherein the configuration information indicates a plurality of candidate TypeD-QCL reference sources, and wherein the indication of the one or more TypeD-QCL reference sources includes a respective indication of a candidate TypeD-QCL reference source, of the plurality of candidate TypeD-QCL reference sources, for each CMR of the one or more second CMRs.
Aspect 35: The method of any of Aspects 33-34, wherein the configuration information indicates a plurality of UE recommendation options for a plurality of candidate TypeD-QCL reference sources, each UE recommendation option, of the plurality of UE recommendation options, corresponding to a respective combination of one or more candidate TypeD-QCL reference sources of the plurality of candidate TypeD-QCL reference sources, and wherein the indication of the one or more TypeD-QCL reference sources includes an indication of an identifier associated with a UE recommendation option of the plurality of UE recommendation options.
Aspect 36: The method of any of Aspects 33-35, wherein the one or more TypeD-QCL reference sources are associated with one or more downlink or uplink reference signals.
Aspect 37: The method of any of Aspects 33-36, wherein the one or more TypeD-QCL reference sources are associated with one or more downlink angle of arrival (AoA) or angle of departure (AoD) values.
Aspect 38: The method of any of Aspects 24-25 and 28-37, wherein the indication of the one or more second CMRs is included in the first CSI report.
Aspect 39: The method of any of Aspects 24-25 and 28-37, wherein the first CSI report includes an indication of a recommendation to change CMRs to be used to predict measurements for the CPRs, and wherein the indication of the one or more second CMRs is included in an aperiodic CSI report triggered in connection with the indication of the recommendation to change the CMRs to be used to predict measurements for the CPRs.
Aspect 40: The method of Aspect 39, further comprising: transmitting, to the UE, an indication triggering the aperiodic CSI report in connection with the indication of the recommendation to change the CMRs to be used to predict measurements for the CPRs.
Aspect 41: The method of any of Aspects 39-40, wherein the indication of the recommendation to change the CMRs includes a one-bit indication of the recommendation to change the CMRs to be used to predict measurements for the CPRs.
Aspect 42: The method of any of Aspects 39-40, wherein the indication of the recommendation to change the CMRs includes a bitmap including a respective bit corresponding to each first CMR of the one or more first CMRs, wherein the respective bit corresponding to each first CMR indicates a first value in connection with a recommendation to change the first CMR or a second value in connection with a recommendation not to change the first CMR, and wherein the indication of the one or more second CMRs includes an indication of a respective second CMR for each first CMR for which the respective bit corresponding to the first CMR indicates the first value.
Aspect 43: The method of any of Aspects 39-40, wherein the indication of the recommendation to change the CMRs includes an indication of a quantity of first CMRs recommended to be changed of the one or more first CMRs, and wherein the indication of the one or more second CMRs includes an indication of each the first CMRs recommended to be changed and an indication of a respective second CMR for each of the first CMRs recommended to be changed.
Aspect 44: The method of any of Aspects 24-43, wherein the configuration information indicates a first CMR pattern for varying CMRs to be used for predicting measurements of the CPRs across multiple time domain measurement occasions, wherein the one or more first CMRs are associated with the first CMR pattern, wherein the indication of the one or more second CMRs includes an indication of a second CMR pattern for varying CMRs to be used for predicting measurements of the CPRs across multiple time domain measurement occasions, and wherein the one or more second CMRs are associated with the second CMR pattern.
Aspect 45: The method of any of Aspects 24-44, wherein the indication of the one or more second CMRs includes an indication of a recommended time duration associated with the one or more second CMRs.
Aspect 46: An apparatus for wireless communication at a device, comprising one or more processors; one or more memories coupled with the one or more processors; and instructions stored in the one or more memories and executable by at least one processor of the one or more processors to cause the apparatus to perform the method of one or more of Aspects 1-45.
Aspect 47: A device for wireless communication, comprising one or more memories and one or more processors coupled to the one or more memories, at least one processor of the one or more processors configured to perform the method of one or more of Aspects 1-45.
Aspect 48: An apparatus for wireless communication, comprising at least one means for performing the method of one or more of Aspects 1-45.
Aspect 49: A non-transitory computer-readable medium storing code for wireless communication, the code comprising instructions executable by a processor to perform the method of one or more of Aspects 1-45.
Aspect 50: A non-transitory computer-readable medium storing a set of instructions for wireless communication, the set of instructions comprising one or more instructions that, when executed by one or more processors of a device, cause the device to perform the method of one or more of Aspects 1-45.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, andc+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

1. An apparatus for wireless communication at a user equipment (UE), comprising:
one or more memories storing processor-executable code; and
one or more processors coupled with the one or more memories, at least one processor of the one or more processors configured to cause the UE to:
receive, from a network node, configuration information indicating one or more channel prediction resources (CPRs) associated with a channel state information (CSI) report and one or more first channel measurement resources (CMRs) to be used for predicting measurements for the one or more CPRs;
perform measurements of the one or more first CMRs;
transmit, to the network node, a first CSI report including first predicted measurement values associated with the one or more CPRs, the first predicted measurement values in accordance with the measurements of the one or more first CMRs; and
transmit, to the network node, an indication of one or more second CMRs to be used for predicting measurements for the one or more CPRs.

2. The apparatus of claim 1, wherein at least one processor of the one or more processors is configured to cause the UE to:
perform measurements of the one or more second CMRs in association with transmitting the indication of the one or more second CMRs; and
transmit, to the network node, a second CSI report including second predicted measurement values associated with the one or more CPRs, the second predicted measurement values in accordance with the measurements of the one or more second CMRs.

3. The apparatus of claim 1, wherein, to cause the UE to transmit the indication of the one or more second CMRs, at least one processor of the one or more processors is configured to cause the UE to:
transmit a medium access control (MAC) control element (MAC-CE) including the indication of the one or more second CMRs.

4. The apparatus of claim 3, wherein at least one processor of the one or more processors is configured to cause the UE to:
receive, from the network node, an acknowledgement of the MAC-CE;
perform measurements of the one or more second CMRs in a next time domain measurement occasion after a time offset from receiving the acknowledgement; and
transmit, to the network node, a second CSI report including second predicted measurement values associated with the one or more CPRs, the second predicted measurement values in accordance with the measurements of the one or more second CMRs.

5. The apparatus of claim 1, wherein at least one processor of the one or more processors is configured to cause the UE to:
receive, from the network node, a confirmation that the one or more second CMRs are to be used for predicting measurements for the one or more CPRs;
perform measurements of the one or more second CMRs in a time domain measurement occasion subsequent to receiving the confirmation; and
transmit, to the network node, a second CSI report including second predicted measurement values associated with the one or more CPRs, the second predicted measurement values in accordance with the measurements of the one or more second CMRs.

6. The apparatus of claim 1, wherein the configuration information indicates a plurality of UE recommendation options for a plurality of CMRs, each UE recommendation option, of the plurality of UE recommendation options, corresponding to a respective combination of one or more CMRs of the plurality of CMRs, and wherein the indication of the one or more second CMRs includes an indication of an identifier associated with a UE recommendation option of the plurality of UE recommendation options.

7. The apparatus of claim 1, wherein the configuration information indicates a plurality of CMR sets, and wherein the indication of the one or more second CMRs includes an indication of a CMR set identifier associated with a CMR set of the plurality of CMR sets.

8. The apparatus of claim 1, wherein the configuration information indicates a plurality of CMR sets, and wherein the indication of the one or more second CMRs includes, for each CMR of the one or more second CMRs, a respective indication of a CMR set identifier that identifies a CMR set, of the plurality of CMR sets, and a respective indication of a CMR identifier that identifies the CMR within the CMR set.

9. The apparatus of claim 1, wherein the indication of the one or more second CMRs includes an indication of one or more Type D quasi co-location (TypeD-QCL) reference sources associated with the one or more second CMRs.

10. The apparatus of claim 9, wherein the configuration information indicates a plurality of candidate TypeD-QCL reference sources, and wherein the indication of the one or more TypeD-QCL reference sources includes a respective indication of a candidate TypeD-QCL reference source, of the plurality of candidate TypeD-QCL reference sources, for each CMR of the one or more second CMRs.

11. The apparatus of claim 9, wherein the configuration information indicates a plurality of UE recommendation options for a plurality of candidate TypeD-QCL reference sources, each UE recommendation option, of the plurality of UE recommendation options, corresponding to a respective combination of one or more candidate TypeD-QCL reference sources of the plurality of candidate TypeD-QCL reference sources, and wherein the indication of the one or more TypeD-QCL reference sources includes an indication of an identifier associated with a UE recommendation option of the plurality of UE recommendation options.

12. The apparatus of claim 9, wherein the one or more TypeD-QCL reference sources are associated with one or more downlink or uplink reference signals, or wherein the one or more TypeD-QCL reference sources are associated with one or more downlink angle of arrival (AoA) or angle of departure (AoD) values.

13. The apparatus of claim 1, wherein the indication of the one or more second CMRs is included in the first CSI report or includes an indication of a recommended time duration associated with the one or more second CMRs.

14. The apparatus of claim 1, wherein the first CSI report includes an indication of a recommendation to change CMRs to be used to predict measurements for the CPRs, and wherein the indication of the one or more second CMRs is included in an aperiodic CSI report triggered in connection with the indication of the recommendation to change the CMRs to be used to predict measurements for the CPRs.

15. The apparatus of claim 14, wherein the indication of the recommendation to change the CMRs includes a one-bit indication of the recommendation to change the CMRs to be used to predict measurements for the CPRs.

16. The apparatus of claim 14, wherein the indication of the recommendation to change the CMRs includes a bitmap including a respective bit corresponding to each first CMR of the one or more first CMRs, wherein the respective bit corresponding to each first CMR indicates a first value in connection with a recommendation to change the first CMR or a second value in connection with a recommendation not to change the first CMR, and wherein the indication of the one or more second CMRs includes an indication of a respective second CMR for each first CMR for which the respective bit corresponding to the first CMR indicates the first value.

17. The apparatus of claim 14, wherein the indication of the recommendation to change the CMRs includes an indication of a quantity of first CMRs recommended to be changed of the one or more first CMRs, and wherein the indication of the one or more second CMRs includes an indication of each the first CMRs recommended to be changed and an indication of a respective second CMR for each of the first CMRs recommended to be changed.

18. The apparatus of claim 1, wherein the configuration information indicates a first CMR pattern for varying CMRs to be used for predicting measurements of the CPRs across multiple time domain measurement occasions, wherein the one or more first CMRs are associated with the first CMR pattern, wherein the indication of the one or more second CMRs includes an indication of a second CMR pattern for varying CMRs to be used for predicting measurements of the CPRs across multiple time domain measurement occasions, and wherein the one or more second CMRs are associated with the second CMR pattern.

19. (canceled)

20. An apparatus for wireless communication at a network node, comprising:
one or more memories storing processor-executable code; and
one or more processors coupled with the one or more memories, at least one processor of the one or more processors configured to cause the network node to:
transmit, to a user equipment (UE), configuration information indicating one or more channel prediction resources (CPRs) associated with a channel state information (CSI) report and one or more first channel measurement resources (CMRs) to be used for predicting measurements for the one or more CPRs;
receive, from the UE, a first CSI report including first predicted measurement values associated with the one or more CPRs, the first predicted measurement values in accordance with measurements of the one or more first CMRs; and
receive, from the UE, an indication of one or more second CMRs to be used for predicting measurements for the one or more CPRs.

21.-28. (canceled)

29. A method of wireless communication performed at a user equipment (UE), comprising:
receiving, from a network node, configuration information indicating one or more channel prediction resources (CPRs) associated with a channel state information (CSI) report and one or more first channel measurement resources (CMRs) to be used for predicting measurements for the one or more CPRs;
performing measurements of the one or more first CMRs;
transmitting, to the network node, a first CSI report including first predicted measurement values associated with the one or more CPRs, the first predicted measurement values in accordance with the measurements of the one or more first CMRs; and
transmitting, to the network node, an indication of one or more second CMRs to be used for predicting measurements for the one or more CPRs.

30. (canceled)
